(19) United States
(12) Patent Application Publication
(10) Pub. No.: US 2025/0135684 A1
(43) Pub. Date: May 1, 2025

(54) Extrusion Processes

(71) Applicant: ExxonMobil Technology and Engineering Company, Baytown, TX (US)

(72) Inventors: Jianya Cheng, Kingwood, TX (US); Ronald Deyoung, Westfield Center, OH (US); Mallerie Mccune, Houston, TX (US); Christopher A. Stafford, Pace, FL (US); Abdul M. Jangda, Humble, TX (US); Dinara R. Sunagatullina, Houston, TX (US); Paul T.Q. Nguyen, League City, TX (US); Michael B. Collins, Pensacola, FL (US); Edward J. Blok, Huffman, TX (US)

(21) Appl. No.: 18/699,484

(22) PCT Filed: Oct. 18, 2022
(86) PCT No.: PCT/US2022/046945

§ 371 Date: Apr. 8, 2024

Related U.S. Application Data
(60) Provisional application No. 63/273,501, filed on Oct. 29, 2021.

(51) Int. Cl. B29B 7/48; B29K 21/00; B29K 105/00; C08J 3/22

(52) U.S. Cl. CPC B29B 7/489; C08J 3/22; B29K 2021/00; B29K 2105/0005; C08J 2323/16

(57) ABSTRACT

The present disclosure relates to extrusion processes. In at least one embodiment, a method of forming a functionalized polymer includes introducing a polymer and a coupling agent to an extruder at a feed throat of the extruder. The method includes extruding the polymer and the coupling agent through at least a portion of the extruder via a plurality of intermeshing screws disposed within the extruder to form the functionalized polymer. The at least one screw of the plurality of intermeshing screws has a first mixing zone having a total length of about 4 L/D to about 6 L/D, a second mixing zone having a total length of 2.5 L/D to 3.5 L/D, and a third mixing zone having a total length of about 2.5 L/D to about 4.5 L/D.

### CROSS REFERENCE TO RELATED APPLICATIONS

This application claims priority to and the benefit of U.S. Provisional Application No. 63/273,501, filed Oct. 29, 2021, the disclosure of which is incorporated herein by reference in its entirety.

### FIELD

The present disclosure relates to extrusion processes.

### BACKGROUND

Blends of highly saturated specialty elastomers blended with highly unsaturated polymers can be desired to improve the performance window of the blend (e.g., oxygen & ozone resistance, thermal stability, tack, etc). For example, the physical properties of specialty elastomers blended with highly unsaturated tire polymers are generally unsatisfactory due to poor physical properties. The poor physical properties are due to cure incompatibilities caused by significant differences in polarity of the elastomers (curatives preferring the more polar polymers) and the much lower level of unsaturation of EPDM or Butyl. Both of these facts lead to a much higher cure state (cross-linking level) for SBR, BR & NR vs. the EPDM & Butyl polymers.

Over the years, most approaches to address this have sought to increase the cure rate of the specialty polymers in blends with highly unsaturated polymers via increasing the unsaturation level, selecting accelerators with greater solubility in less polar polymers, premixing accelerators and sulfur into EPDM & Butyl, and modification of EPDM & Butyl with sulfur accelerators (solution, curing & batch mixing). Although these methods have shown a modest improvement in physical properties, these methods have not been commercially viable options.

In addition, the larger the batch mixer size, the harder it is to control the batch temperature (reaction). It is also much more difficult to control the end of the reaction in a batch process, resulting in thick slabs of rubber that are difficult to cool.

For tire tread in particular, tire tread compounds in a tire dictate properties of the tire, such as wear, traction, and rolling resistance. It is a technical challenge to deliver excellent traction, low rolling resistance while providing good tread wear. The challenge lies in the trade-off between wet traction and rolling resistance/tread wear. One way to improve rolling resistance and wet braking is to incorporate a series of polyolefin additives based on butyl copolymer rubber, ethylene-propylene-diene terpolymer, and poly(isobutylene-co-paramethylstyrene-co-isoprene) terpolymer in tire tread compositions. Development of an immiscible polyolefin (PO) additive, which may be functionalized, increases hysteresis in the wet traction region (0° C.) and lowers hysteresis in the rolling resistance region (60° C.) without changing the overall compound glass transition temperature (Tg) by improving the interface between the polymer domain and the tread matrix.

There is a need for improved processes for providing functionalized polymers, e.g., for use in tire tread compositions.

References for citing in an information disclosure statement (37 C.F.R. 1.97 (h)): U.S. Pat. Nos. 4,687,810; 6,279,633; 6,539,996; 7,423,089; 7,655,728; 10,882,981; U.S. Pub. No. US 2010/037519; U.S. Pub. No. 2017/0015911; U.S. Pub. No. 2020/0247009; WO 2019/226843; WO2021/126625; Mastromatteo, R P., Mitchell, J. M. and Brett, Jr., T. J. (1971) New accelerators for blends of EPDM. Rubber Chemistry and Technology, 44 (4), 1065-1079; Woods, M. E. and Mass, T. R (1975) Fundamental considerations for the covulcanization of elastomer blends, in Copolymers, PolybLends and Composites-Advances in Chemistry Series (ed. N. AJ. Platzer), vol. 142, pp. 386-398; Morrissey, RT. (1971) Halogenation of ethylene propylene diene rubbers. Rubber Chemistry and Technology, 44 (4), 1025-1042; Baranwal, K. C. and Son, P. N. (1974) Co-curing of EPDM and diene rubbers by grafting accelerators onto EPDM. Rubber Chemistry and Technology, 47 (1), 88-99; Hashimoto, K., Miura, M., Takagi, S. and Okamoto, H. (1976) Co-vulcanization of EPDM and NR 1. International Polymer Science and Technology, 3, T84-T87; Hopper, R J. (1976) Improved co-cure of EPDM-polydiene blends by conversion of EPDM into macromolecular cure retarder. Rubber Chemistry and Technology 49 (1), 341-352; Andrew J. Tinker & Kevin P. Jones (1998), Blends of Natural Rubber Novel Techniques for Blending with Specialty Polymers: Andrew J. Tinker & Kevin P. Jones. Chapter 14 Solutions to basic problems of poor physical properties on NR/EPDM blends, Stuart Cook; Compounding and Mixing Methodology for Good Performance of EPDM in Tire Sidewalls; Tire Technology Expo 2018; Feb. 20, 2018, Phillip Hough; Andrew J. Tinker & Kevin P. Jones (1998), Blends of Natural Rubber Novel Techniques for Blending with Specialty Polymers: Andrew J. Tinker & Kevin P. Jones. Chapter 16 Compounding NR/EPDM blends for light-coloured applications, Stuart Cook & Maria Escolar; Sombatsompop, N., (1998), Analysis of cure characteristics on cross-link density and type, and viscoelasitc properties of natural rubber, Polym.-Plast. Technol. Eng., 37 (3), 333-349

### SUMMARY

The present disclosure relates to extrusion processes.

In at least one embodiment, a method of forming a functionalized polymer includes introducing a polymer and a coupling agent to an extruder at a feed throat of the extruder. The method includes extruding the polymer and the coupling agent through at least a portion of the extruder via a plurality of intermeshing screws disposed within the extruder to form the functionalized polymer. The at least one screw of the plurality of intermeshing screws has a first mixing zone having a total length of about 4 L/D to about 6 L/D, a second mixing zone having a total length of 2.5 L/D to 3.5 L/D, and a third mixing zone having a total length of about 2.5 L/D to about 4.5 L/D. The first mixing zone is a mixing zone closest to the feed throat of the extruder, the second mixing zone is disposed downstream of the first mixing zone relative to the feed throat, and the third mixing zone is disposed downstream of the second mixing zone relative to the feed throat.

### BRIEF DESCRIPTION OF THE FIGURES

To assist those of ordinary skill in the relevant art in making and using the subject matter hereof, reference is made to the appended figures, wherein:

FIG. 1 is a graph illustrating the residence time distribution for the various example screw designs, according to an embodiment.

FIG. 2 illustrates 1H-NMR spectra of example thiol-treated, sulfur functionalized EPDM examples (Ex. 3, Ex. 2, Ex. 1, Ex. 5, and Ex. 4) and the untreated EPDM, according to an embodiment.

FIG. 3 illustrates 1H-NMR spectra of example thiol-treated, sulfur functionalized butyl rubber examples (Ex. 7 and Ex. 6) and the untreated butyl rubber (Butyl 065), according to an embodiment.

FIG. 4 is a graph illustrating the results from dynamic mechanical thermal analysis (DMTA) measurements at 4% strain and 10 Hz of compositions, according to an embodiment.

### DETAILED DESCRIPTION

The present disclosure relates to extrusion processes. The issues described above may be overcome via reactive extrusion processes of the present disclosure. High throughputs can be achieved on a reactive extrusion continuous process with much more control of shear and temperatures along with variable shear and temperature zones. The higher mixing intensity and high degree of surface renewal can be ideal for sulfur grafting on to the selected polymers. High mixing intensity can also break the poly-sulfidic cross-linking and allow for further functionalization (drive reaction further). These benefits cannot be achieved via batch mixers where only one rotor configuration is used per batch. Cooling of the resulting composition is also much more uniform with reactive extrusion processes of the present disclosure as small pellets may be formed in an underwater pelletization process vs. dropping on a mill and then going into a water tray for the batch process.

Extrusion processes of the present disclosure can provide the ability to increase the degree of functionalization of polymers by screw design and process conditions. These functionalized polymers were evaluated as wet traction additives in tire tread compositions and demonstrated equivalent physical properties to the control tread once functionalization levels were high enough.

The extrusion processes described herein can provide formation of compositions having improved physical properties such as tensile strength, elongation at break, and modulus, as well as improved performance properties, such as wet braking and rolling resistance, relative to, for example, conventional tire tread compositions.

Extrusion processes of the present disclosure can provide functionalized polymers having a high degree of functionalization. The functionalized polymers can be used as tire tread compounds (additives) that provide good wet traction without increasing rolling resistance and tread wear to tire tread. Extrusion processes of the present disclosure provide functionalized polymers (via reactive extrusion) and compositions (e.g., tire products) having improved wet traction and rolling resistance while maintaining wear resistance performance.

Processes of the present disclosure provide commercially viable processes to functionalize elastomers like EPDM and butyl to allow them to make effective blends with highly unsaturated polymers like NR, SBR, and BR.

It would be expected that a highly cross-linked material would be formed in the extruder (effectively clogging the extruder with thermoset material). However, the inventors have discovered that this did not occur. For example, processes and extruder systems of the present disclosure can break disulfide bonds (e.g., crosslinking) that do form in the extrudate and provide compositions (e.g., tire products) having very fine morphology.

Overall, extrusion processes of the present disclosure provide functionalized polymers, e.g., as tire tread additives and compositions (e.g., tire products) having improved wet traction and rolling resistance while maintaining wear resistance performance, as compared to functionalized polymers having a lower degree of functionalization.

For purposes of the present disclosure, when a polymer is referred to as comprising an olefin, the olefin present in the polymer is the polymerized form of the olefin, respectively. Likewise the use of the term polymer is meant to encompass homopolymers and copolymers, where copolymers include any polymer having two or more chemically distinct monomers.

For the purposes of this disclosure, the term “polypropylene” as used herein means polymers containing propylene as monomers, it can be homopolypropylene or copolymer of propylene and α-olefin comonomers.

For the purposes of this disclosure, the term “polyethylene” as used herein means polymers containing ethylene as monomers, it can be homopolyethylene or copolymer of ethylene and α-olefin comonomers.

As used herein, a “composition” can include the components of the composition and/or one or more reaction product(s) of the components.

As used herein, a “tire product”, also referred to as “tire tread”, is a composition of the present disclosure that has been shaped to resemble at least a portion of a tire.

### Extruders

An extruder of the present disclosure used for polymer functionalization can be any suitable multiscrew (e.g., twin screw) extruder (small scale or industrial scale), such as those commercially available from ThermoFisher Scientific Inc.

For example, an extruder can be a batch extruder having a first port for providing solid components (of the extrudate to be formed) and a liquid port for providing liquid components (of the extrudate to be formed).

A high degree of functionalization of polymers can be provided using any suitable screw design of the present disclosure. One or more screws of a multiscrew extruder has a screw design of the present disclosure.

The elements of a screw can be classified as one of a conveying element, a kneader (also referred to as a kneading block), a back flow element, a flow splitter, or a restrictive conveying element. In some embodiments, a screw of the present disclosure comprises one or more conveying element, one or more kneading block, one or more back flow element, one or more flow splitter, one or more restrictive conveying element, or combination(s) thereof in any suitable configuration. Conveying elements are fluted screws of various pitches that are designed to move the extrudate forward in the mixing barrel. Kneaders tend to restrict the flow of the extrudate, and the kneaders provide extreme shearing, particle size reduction, and heat generation. Back flow elements are fluted to reverse the flow of the extrudate, and act as restricting or blocking elements. Restrictive conveying elements can be single flight elements with wide crest or those with slotted flighting which kneads the extrudate as it is conveyed forward. Restrictive conveying elements can have low pitched flights or high pitched flights with slots.

The screw elements are described commercially in their design by letter and number designations. The number and letter designations and the screw elements are available from Century Extruders, Traverse City, Mich.

S and SK refer to conveying elements which do some mixing, but are used mainly to push material in the extruder from the rubber feeder end to the extruding end. The SK elements are conveying elements with a higher free volume than regular conveying elements, and are used as transition elements between flow zones. SG refers to elements that convey the extruding material while providing substantial mixing.

KB refers to kneading elements. The kneaders do not have a large bias toward moving the extruding material forward, and tend toward filling with material from upstream in the extruder. The kneaders may comprise any number of plates that may have one or more points. For example, a two point kneading plate has a generally parallelogram shape with two points corresponding to the maximum diameter of the plate, and a three point kneading plate has three similar maximum diameter points and three corresponding flat areas with a diameter close to the diameter of the screw shaft. When a back flow conveyer is used in conjunction with a kneader, filling of the flow zone around the kneader is assured, and the increased pressure and shearing caused by the filling has a tendency to dramatically increase the temperature of the extruding material.

Numbers in the screw element designations refer to the pitch of the flutes, the length of the element and the number of plates in the element. Additional letters refer to their orientation left (L) or right (R) and their type. In the description, the letter ‘N’ denotes that the elements are ‘neutral’, and provide no conveying action in either direction.

S060R030, for example, refers to a conveying element (S), having a flute pitch of 060 mm to the right (R), and having a length of 30 mm. Similarly, KBS405R030 refers to a kneader (KBS) having a separation of 45° between adjacent plate tips, five plates with a right hand conveying bias, and a length of 30 mm. S040RL040 Igel and KBS905N030 are flow splitting elements that cut the extruding flow into two or more streams, and directs the divided streams left (L) and right (R) back upon themselves. These flow splitting elements cause a crossover between the inner and outer extrudate streams. S030L015 refers to a back flow conveying element having a pitch of 30 mm to the left (L), and a length of 15 mm. The L designation describes the pitch direction of the fluting as tending to push the extruding material back toward the feed throat, sometimes referred to as reverse flow.

The back flow elements, the kneaders and other non-conveying or low conveying elements, cause a build up of pressure in their particular flow zones, until the pressure of feeding material and the pressure caused by the upstream conveying elements overcomes the back pressure, and forces the extruding material through the respective flow zone.

In the illustrated embodiments, back flow elements, when they are used, are at the end of a flow or mixing zone. Since the back flow elements create a dam, it is deemed that they define the end of a flow zone. Similarly, since a restrictive conveying element produces high pressure in its flow zone, the end of such an element, where the pressure is released into a forward conveying element, is considered to be the end of a flow zone.

The function of each flow zone can be defined by its shear rate, and the number of shears carried out in the flow zone. The kneaders and flow splitters, for example, are used for melting and increasing the temperature of the extrusion, in addition to the mixing they provide, and are designed to produce a large number of shears. The conveying elements provide some mixing, but are designed mainly to move the extrusion along, and do not produce as many shears as the kneaders. Most of the other mixing elements fall somewhere between the kneaders and the conveying elements in their mixing capability and their shearing capability.

As illustrated in U.S. Pat. No. 4,594,390, shear rate is defined by C×RPM/tip clearance (where the ‘tip clearance’ is the distance between the tip of the screw and the wall of the extruding chamber (e.g., mixing barrel)), and C is the circumference of the element. In other words, the shear rate is the tip velocity divided by the tip clearance. The number of shears, therefore, is the ‘shear rate ‘x’ the length of the particular flow zone’, and the shear rate is directly related to the mixing aggressiveness of a particular screw profile. In processes of the present disclosure, shear rates of 400 sec⁻¹ or greater can be effectively used.

There is substantial shearing between the tips of the screws and the bottom of the grooves of adjacent intermeshing screws, and the prior calculations do not completely describe the mixing process, and for the purposes of the present disclosure, the mixing ability of a particular screw profile may be described in terms of the ‘meshes’ of the screw, and the ‘intermeshes’ of a plurality of intermeshing screws. As used herein, ‘meshes’ refers to the mixing potential of a particular screw element or profile, and ‘intermeshes’ refers to the mixing potential of a plurality of intermeshing screws.

The number of shears created by a specific screw element is dependent on the profile of that element, and the number of shears created between the screw tips and the mixing barrel will be an inherent property of the element profile, and the calculation of the meshes and intermeshes of the screws is a more satisfactory method of determining a screw profile's processing ability than the methods described in the prior art.

During processing, when the screws are rotating at a specific RPM, the number of intermeshes/sec, or intermeshes sec⁻¹, can be calculated, as a measure of the amount of mixing taking place in the extrudate. The amount of mixing that goes into the processing of a particular extrudate further depends on the feed rate of the materials, the RPM of the extruder screws, the viscosity ratio and temperature of the materials, their surface wetting properties, the surface tension of the particles, and their flow characteristics.

In some embodiments, an extrusion is performed at an extruder temperature (e.g., internal temperature of the barrel) of about 100° F. to about 700° F., such as about 150° F. to about 400° F., such as about 200° F. to about 300° F.

In some embodiments, a screw has a first mixing zone, a second mixing zone, and a third mixing zone. The first mixing zone can be the mixing zone closest to the feed throat of the extruder. The second mixing zone can be disposed downstream of the first mixing zone (relative to the feed throat of the extruder). The third mixing zone can be disposed downstream of the second mixing zone (relative to the feed throat of the extruder). In addition, a flow zone having one or more conveying elements can be disposed between the first mixing zone and the second mixing zone. A flow zone having one or more conveying elements can be disposed between the second mixing zone and third mixing zone. The first mixing zone, the second mixing zone, and the third mixing zone each have one or more left handed (forward) kneading blocks and one or more neutral convey kneading blocks.

In some embodiments, the first mixing zone has a total length of about 4 L/D to about 6 L/D, such as about 5 L/D. “L/D” is the ratio of the total length of the mixing zone divided by the diameter (e.g., average diameter) of the mixing zone. The first mixing zone can have a ratio of about 0.5 to about 0.75, such as about 0.67, of the total length of the left handed (forward) kneading blocks of the first mixing zone to the total length of the neutral convey kneading blocks of the first mixing zone.

In some embodiments, the second mixing zone has a total length of about 2.5 L/D to about 3.5 L/D, such as about 3 L/D. The second mixing zone can have a ratio of about 0.8 to about 2, such as about 1 to about 1.3, of the total length of the left handed (forward) kneading blocks of the second mixing zone to the total length of the neutral convey kneading blocks of the second mixing zone.

In some embodiments, the third mixing zone has a total length of about 2.5 L/D to about 4.5 L/D, such as about 3 L/D to about 3.5 L/D. The third mixing zone can have a ratio of about 0.5 to about 2.5, such as about 0.8 to about 2, of the total length of the left handed (forward) kneading blocks of the third mixing zone to the total length of the neutral convey kneading blocks of the third mixing zone.

In some embodiments, the contents of the feed throat of the extruder enters an initial flow zone of the screw, the initial flow zone having one or more conveying elements. The contents is conveyed from the initial flow zone to the first mixing zone, and the first mixing zone begins at about 0.8 fold (referred to as “0.8×”) to about 1.2 fold (referred to as “1.2×”), such as about 1×, the length of the longest mixing zone of the screw.

In some embodiments, a distance between the first mixing zone and the second mixing zone is about 0.3× to about 2× the length of the longest mixing zone of the screw, such as about 0.4× to about 1.2×, such as about 0.6× to about 1×. In some embodiments, a distance between the second mixing zone and the third mixing zone is 0.0.15× to about 1.5× the length of the longest mixing zone of the screw, such as about 0.2× to about 1.2×, such as about 0.3× to about 1×, such as about 0.4× to about 0.9×, such as about 0.5× to about 0.6×.

In some embodiments, a screw of the present disclosure has a fourth mixing zone. The fourth mixing zone can include one or more forward (left handed) kneading blocks and one or more neutral convey kneading blocks. The fourth mixing zone can be disposed downstream of the third mixing zone (relative to the feed throat of the extruder).

In some embodiments, the fourth mixing zone has a total length of about 4 L/D to about 6 L/D, such as about 5 L/D.

The fourth mixing zone can have a ratio of about 0.5 to about 1, such as about 0.67, of the length of the left handed (forward) kneading blocks of the fourth mixing zone to the length of the neutral convey kneading blocks of the fourth mixing zone.

In some embodiments, a distance between the third mixing zone and the fourth mixing zone is about 0.2× to about 1.7×, such as about 0.3× to about 1.5×, 0.4× to about 1.3× the length of the longest mixing zone of the screw, such as about 0.5× to about 1.1×, such as about 0.6× to about 1×.

Residence times for the extrudate in an extruder of processes of the present disclosure can be determined empirically by adding color to the feed throat of the extruder after the start of extrusion from the die, and measuring the time occurred for a color change to appear at the extrusion die. In some embodiments, a residence time can be 15 to 180 seconds, depending on the materials being processed.

In some embodiments, a processing oil is added in one location or a plurality of locations along the extruder, in order to control the temperature and the consistency of the composition as it is being processed, as well as to control the properties of an extrudate end product.

In some embodiments, specific energy of the extruder is about 0.17 to 0.28 kW/kg.

In some embodiments, the extruder can be operated at an output capacity of about 10 kilograms per hour (kg/h) to about 6,000 kg/h, such as about 10 kg/h to about 300 kg/h, alternatively about 300 kg/h to about 1,500 kg/h, alternatively about 1,500 kg/h to about 3,000 kg/h, alternatively about 3,000 kg/h to about 6,000 kg/h.

Upon exiting the die of the extruder, the composition can be pelletized. For example, the composition may be fed to a pelletizer where the composition is then discharged through a pelletization die as formed pellets. The pellets may be used to form tire products of the present disclosure. Pelletization of the composition may be by an underwater, hot face, strand, water ring, or other similar pelletization. Preferably an underwater pelletizer is used, but other equivalent pelletizing units known to those skilled in the art may also be used. Small pellets may be formed in an underwater pelletization process vs. dropping the composition on a mill and then going into a water tray for a batch process. Small pellets provides tire products having improved compositional uniformity.

### Functionalized Polymers and Compositions Thereof

Compositions of the present disclosure include one or more functionalized polymer (e.g., rubber), a plasticizer, a carbon material, a coupling agent (e.g., unreacted coupling agent from an extrusion process), and an antioxidant. In some embodiments, a composition further includes a diene elastomer. A diene elastomer can be introduced to the extruder (e.g., as a solid) of a process of the present disclosure. Similarly, a plasticizer can be introduced (e.g., as a solid) to the extruder. Alternatively, a diene elastomer and/or a plasticizer can be compounded with a composition post-extrusion by any suitable method.

A functionalized polymer can be a functionalized butyl rubber, a functionalized ethylene-propylene-diene terpolymer, a functionalized poly(isobutylene-co-para-methylstyrene-co-isoprene) terpolymer, or combination(s) thereof. The functionalized polymer can have any suitable functional group formed using a coupling agent of the present disclosure. For example, a functional group can be a sulfur or silane functional group.

The functionalized polymer can have a higher degree of functionalization, as compared to conventional functionalized polymers formed using conventional screws and methods. For example, a functionalized polymer can have a degree of functionalization (defined as the ratio of substituted vinyl (e.g., S—CHx) to vinylic hydrogen measured by 1H NMR) of about 0.2 to about 1.8, such as about 0.4 to about 1.6, such as about 0.7 to about 1.4, such as about 0.9 to about 1.1, alternatively about 0.2 to about 0.5. A high degree of functionalization provides similar polarity between, for example, a functionalized EPDM or functionalized butyl with highly unsaturated SBR, BR, and NR. The improved similarity of polarity (via increased degree of functionalization) provides improved wet braking, rolling resistance, and maintains wear performance when the functionalized polymer is used as a tire tread additive in a tire product of the present disclosure.

For example, functionalized polymers of the present disclosure can provide improved wet braking (tan δ @ 0° C.) and rolling resistance (tan δ @ 60° C.), and maintained wear performance when used in a tire product. A higher value of tan δ @ 0° C. indicates better wet braking. A lower value of tan δ @ 60° C. indicates better rolling resistance. In addition, functionalized polymers of the present disclosure have improved similarity of polarity between the functionalized polymer and other polymers of the composition (e.g., tire), which can be quantified according to tan δ @−12° C. The higher the value of tan δ @−12° C., the better the interface (e.g., finer the morphology and/or thicker the interface) between the functionalized polymer and other polymers of the tire.

To determine tan δ values, Dynamic Mechanical Thermal Analysis (“DMTA”) tests can be conducted on functionalized polymer samples to provide information about the small-strain mechanical response of the sample as a function of temperature. Sample specimens can tested using a commercially available DMA instrument (e.g., TA Instruments DMA 2980 or Rheometrics RSA) equipped with a dual cantilever test fixture. The specimen can be cooled to −70° C. and then heated to 100° C. at a rate of 2° C./min while being subjected to an oscillatory deformation at 0.1% strain and a frequency of 6.3 rad/sec. The output of the DMTA test is the storage modulus (E′) and the loss modulus (E″). The storage modulus indicates the elastic response or the ability of the material to store energy, and the loss modulus indicates the viscous response or the ability of the material to dissipate energy. The ratio of E″/E′, called Tan-Delta, gives a measure of the damping ability of the material; peaks in Tan Delta are associated with relaxation modes for the material.

Based on such physical properties, the sulfur functionalized polymers of the present disclosure provide better compatibility and co-curability (e.g., equal to the comparatives discussed below) while the unfunctionalized polymers are not desirable.

Because of advantageous processes of the present disclosure, compositions of the present disclosure can be substantially free of (e.g., completely free of) inorganic fillers (e.g., tire products having compositions of the present disclosure). In some embodiments, a composition has an inorganic filler content of about 0 parts per hundred rubber (phr) to about 100 phr, such as 1 phr to about 10 phr, alternatively 0 phr to about 5 phr, such as 0 phr.

In some embodiments, a composition includes, per 100 parts by weight of rubber (phr) (e.g., per 100 parts by weight of the functionalized polymer), about 0 or 0.01 to about 15 phr plasticizer, such as about 0.01 to about 10 phr plasticizer.

In some embodiments, a composition includes, per 100 parts by weight of rubber (phr) (e.g., per 100 parts by weight of the functionalized polymer), about 0.1 to about 1 phr carbon material. In another embodiment, a composition includes, per 100 parts by weight of rubber (phr), about 0.1 to about 0.5 phr carbon material. In a further embodiment, a composition includes, per 100 parts by weight of rubber (phr), about 0.1 to about 0.3 phr carbon material.

In some embodiments, a composition includes, per 100 parts by weight of rubber (phr) (e.g., per 100 parts by weight of the functionalized polymer), about 0.1 to about 10 phr coupling agent. In another embodiment, a composition includes, per 100 parts by weight of rubber (phr), about 1 to about 5 phr coupling agent. In a further embodiment, a composition includes, per 100 parts by weight of rubber (phr), about 2 to about 3 phr coupling agent.

In some embodiments, a composition includes, per 100 parts by weight of rubber (phr) (e.g., per 100 parts by weight of the functionalized polymer), about 0 or 0.01 to about 2 phr antioxidant.

### Coupling Agents

As used herein, the term “coupling agent” is meant to refer to an agent capable of facilitating stable chemical and/or physical interaction between two otherwise non-interacting species, e.g., between a diene elastomer and polymer of a composition of the present disclosure.

The coupling agent can also include combinations of one or more coupling agents. For example, the coupling agent may be a sulfur-based coupling agent (such as elemental sulfur), an organic peroxide-based coupling agent, an inorganic coupling agent, a polyamine coupling agent, a resin coupling agent, a sulfur compound-based coupling agent, oxime-nitrosamine-based coupling agent, and combination(s) thereof. Among these, for a rubber composition for tires, a non-limiting example coupling agent is a sulfur-based coupling agent.

In an aspect, the coupling agent is a silane coupling agent. Non-limiting examples of silane coupling agents include organosilanes or polyorganosiloxanes. Particular silanes used in the present terpolymer and tire tread compositions include silanes of the following structures:

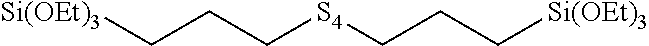

### Bis[3-(triethoxysilyl)propyl]polysulfide (TESPT),

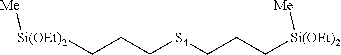

Bis[3-(methyl diethoxysilyl)propyl]polysulfide (BMDE),

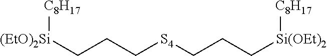

Bis[3-(octyl diethoxysilyl)propyl]polysulfide (BODE),

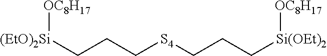

Bis[3-(diethoxy octyloxysilyl)propyl]polysulfide (BDEO),

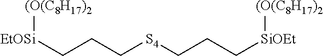

Bis[3-(ethoxy dioctyloxysilyl)propyl]polysulfide (BEDO),

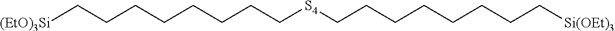

### Bis[8-(triethoxysilyl)octyl]polysulfide (BTEO), and

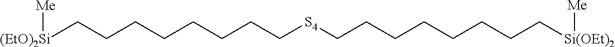

Bis[8-(methyl diethoxysilyl)octylpolysulfide (BMDEO).

Other examples of suitable silane coupling agents include silane polysulfides, referred to as “symmetrical” or “unsymmetrical” depending on their specific structure.

Silane polysulphides can be described by the formula (V):

Z-A-Sₓ-A-Z (V)

in which x is an integer from 2 to 8 (such as from 2 to 5); the A symbols, which are identical or different, represent a divalent hydrocarbon radical (such as a C₁-C₁₈ alkylene group or a C₆-C₁₂ arylene group, more particularly a C₁-C₁₀, in particular C₁-C₄, alkylene, especially propylene); the Z symbols, which are identical or different, correspond to one of the three formulae (VIa, VIb, and VIc):

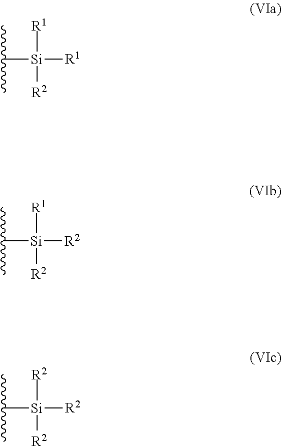

in which the R¹ radicals, which are substituted or unsubstituted and identical to or different from one another, represent a C₁-C₁₈ alkyl, C₅-C₁₈ cycloalkyl or C₆-C₁₈ aryl group (such as C₁-C₆ alkyl, cyclohexyl or phenyl groups, in particular C₁-C₄ alkyl groups, more particularly methyl and/or ethyl); the R² radicals, which are substituted or unsubstituted and identical to or different from one another, represent a C₁-C₁₈ alkoxyl or C₅-C₁₈ cycloalkoxyl group (such as a group selected from C₁-C₈ alkoxyls and C₅-C₈ cycloalkoxyls, such as a group selected from C₁-C₄ alkoxyls, in particular methoxyl and ethoxyl).

Non-limiting examples of silane polysulphides include bis((C₁-C₄)alkoxy(C₁-C₄)alkylsilyl(C₁-C₄)alkyl)polysulphides (in particular disulphides, trisulphides or tetrasulphides), such as, for example, bis(3-trimethoxysilylpropyl) or bis(3-triethoxysilylpropyl) polysulphides. Further examples include bis(3-triethoxysilylpropyl)tetrasulphide, abbreviated to TESPT, of formula [(C₂H₅O)₃Si(CH₂)₃S₂]₂, or bis(triethoxysilylpropyl)disulphide, abbreviated to TESPD, of formula [(C₂H₅O)₃Si(CH₂)₃S]₂. Other examples include bis(mono(C₁-C₄)alkoxyldi(C₁-C₄)alkylsilylpropyl) polysulphides (in particular disulphides, trisulphides or tetrasulphides), for example bis(monoethoxydimethylsilylpropyl)tetrasulphide.

The silane coupling agent can also be bifunctional POSs (polyorganosiloxanes), hydroxysilane polysulphides, silanes, or POSs bearing azodicarbonyl functional groups. The coupling agent can also include other silane sulphides, for example, silanes having at least one thiol (—SH) functional group (referred to as mercaptosilanes) and/or at least one masked thiol functional group.

The silane coupling agent can also include combinations of one or more coupling agents such as those described herein, or otherwise known in the art. A coupling agent can comprise alkoxysilane or polysulphurized alkoxysilane. A polysulphurized alkoxysilane is bis(triethoxysilylpropyl)tetrasulphide, which is commercially available by Degussa under the trade name X50S™.

### Polymers

Polymers of the present disclosure can be any suitable polymer for functionalizing with one or more coupling agents. Polymers of the present disclosure can be any suitable polymer for use in an extruder system of the present disclosure. In some embodiments, a polymer is a butyl rubber (e.g., butyl copolymer rubber), an ethylene-propylene-diene terpolymer, poly(isobutylene-co-para-methylstyrene-co-isoprene) terpolymer, or combination(s) thereof. These polymers, which may be functionalized using an extrusion system of the present disclosure, are useful in tire tread compositions. For example, the functionalized polymers can increase hysteresis in the wet traction region (0° C.) and lowers hysteresis in the rolling resistance region (60° C.). Once functionalized, the polymer is present in a composition of the present disclosure as a functionalized polymer which can be a functionalized butyl rubber, a functionalized ethylene-propylene-diene terpolymer, a functionalized poly(isobutylene-co-para-methylstyrene-co-isoprene) terpolymer, or combination(s) thereof.

### Butyl Rubber

The butyl copolymer rubbers are prepared by polymerizing (i) C₄-C₇ isoolefins with (ii) C₄-C₁₄ conjugated dienes. The butyl copolymer rubbers contain from 85 to 99.5 mol % C₄-C₇ isoolefins and from 0.5 to 15 mol % C₄-C₁₄ conjugated dienes. For example, the 30 butyl copolymer rubber is Butyl 365 (ExxonMobil Chemical). In an embodiment, the butyl copolymer rubbers may be halogenated. For example, the halogenated butyl copolymer rubber is Exxon™ bromobutyl rubber or Exxon™ chlorobutyl rubber.

The term “butyl rubber” or “butyl rubber copolymer” as used in the specification means copolymers of C₄ to C₇ isoolefins and C₄ to C₁₄ conjugated dienes which comprise about 0.5 to about 15 mol % conjugated diene and about 85 to 99.5 mol % isoolefin. Illustrative examples of the isoolefins which may be used in the preparation of butyl rubber are isobutylene, 2-methyl-1-propene, 3-methyl-1-butene, 4-methyl-1-pentene and beta-pinene. Illustrative examples of conjugated dienes which may be used in the preparation of butyl rubber are isoprene, butadiene, 2,3-dimethyl butadiene, piperylene, 2,5-dimethylhexa-2,4-diene, cyclopentadiene, cyclohexadiene and methylcyclopentadiene. The preparation of butyl rubber is described in U.S. Pat. No. 2,356,128 and is further described in an article by R. M. Thomas, et al. in Ind. & Eng. Chem., vol. 32, pp. 1283 et seq., October 1940. Butyl rubber generally has a viscosity average molecular weight between about 100,000 to about 1,500,000, such as about 250,000 to about 800,000 and a Wijs Iodine No. (INOPO) of about 0.5 to 50, such as 1 to 20 (for a description of the INOPO test, see Industrial and Engineering Chemistry, Vol. 17, p. 367, 1945).

The term “butyl rubber” also encompasses functionalized butyl rubber compounds described herein. The butyl rubber may have a C₄ to C₇ isoolefin(s) amount of from about 85 to about 99.5 mol %, or from about 90 to about 99.5 mol % or from about 95 to about 99.5 mol %, based on the weight of the butyl rubber.

The butyl rubber may have a C₄ to C₁₄ conjugated diene(s) amount of from about 0.5 to about 15 mol %, or from about 0.5 to about 10 mol % or from about 0.5 to about 5 mol %, based on the weight of the butyl rubber.

An example of a butyl rubber is BUTYL 365 or 365S (butyl, isobutylene-isoprene rubber (IIR), available from ExxonMobil Chemical Company). BUTYL 365 or 365S is a copolymer of isobutylene and isoprene with about 2.3 mole % unsaturation. Other examples are Exxon BUTYL 065 or 065S (copolymer of isobutylene and isoprene with about 1.05 mole % unsaturation), Exxon BUTYL 068 (copolymer of isobutylene and isoprene with about 1.15 mole % unsaturation) and Exxon BUTYL 268 or 268S (copolymer of isobutylene and isoprene with about 1.7 mole % unsaturation).

In an embodiment, the butyl copolymer rubber may be halogenated. For example, the halogenated butyl copolymer rubber is brominated poly(isobutylene-co-isoprene). Examples of halogenated butyl copolymer rubbers are Exxon™ bromobutyl rubber or Exxon™ chlorobutyl rubber. An example of a halogenated butyl copolymer is Bromobutyl 2222 (ExxonMobil Chemical). Another example of a halogenated butyl rubber is Exxon SBB 6222 (Exxon Mobil), a brominated star branched butyl rubber.

In at least one embodiment, the butyl rubber is functionalized with sulfur.

In another embodiment, the butyl rubber is functionalized with sulfur and an activator. In a further embodiment, the activator is zinc oxide or stearic acid. In a further embodiment, the activator is a combination of zinc oxide and stearic acid.

In another embodiment, the butyl rubber is functionalized with sulfur and a silane coupling agent. In a further embodiment, the silane coupling agent is bis(3-triethoxysilylpropyl)tetrasulphide (TESPT) (available as Si69® from Evonik Industries) and bis[3-(diethoxy octyloxysilyl)propyl]tetrasulfide (from Shin-Etsu).

In another embodiment, the butyl rubber is functionalized with sulfur, an activator and a silane coupling agent.

In another embodiment, the butyl rubber is functionalized with sulfur and a vulcanizing accelerator. In a further embodiment, the vulcanizing accelerator is n-tertiarybutyl-2-benzothiazyl sulfenamide (TBBS).

The compositions may include the butyl rubber in an amount of from 5 phr to 30 phr, or from 5 phr to 25 phr.

### Ethylene-Propylene-Diene Terpolymer

The “ethylene-propylene-diene terpolymer” as used herein may be any polymer comprising propylene and other comonomers. The term “polymer” refers to any carbon containing compound having repeat units from one or more different monomers. The term “terpolymer” as used herein refers to a polymer synthesized from three different monomers.

The ethylene-propylene-diene terpolymers are prepared by polymerizing (i) propylene with (ii) at least one of ethylene and C₄-C₂₀ α-olefins and (iii) one or more dienes such as ethylidene norbornene. In an embodiment, the ethylene-propylene-diene terpolymer may be halogenated. In another embodiment, the ethylene-propylene-diene terpolymer is amorphous ethylene-propylene-diene terpolymer.

Terpolymers, in some embodiments, may be produced (1) by mixing all three monomers at the same time or (2) by sequential introduction of the different comonomers. The mixing of comonomers may be done in one, two, or possible three different reactors in series and/or in parallel. As an example, the ethylene-propylene-diene terpolymer comprises (i) propylene derived units, (ii) α-olefin-derived units and (iii) diene-derived units. The ethylene-propylene diene terpolymer may be prepared by polymerizing (i) propylene with (ii) at least one of ethylene and C₄-C₂₀ α-olefins and (iii) one or more dienes.

The comonomers may be linear or branched. Example linear comonomers include ethylene or C₄ to C₈ α-olefins, such as ethylene, 1-butene, 1-hexene, and 1-octene, such as ethylene or 1-butene. Example branched comonomers include 4-methyl-1-pentene, 3-methyl-1-pentene, and 3,5,5-trimethyl-1-hexene. In one or more embodiments, the comonomers may include styrene.

The dienes may be conjugated or non-conjugated. For example, the dienes are nonconjugated.

Illustrative dienes may include, but are not limited to, 5-ethylidene-2-norbornene (ENB); 1,4-hexadiene; 5-methylene-2-norbornene (MNB); 1,6-octadiene; 5-methyl-1,4-hexadiene; 3,7-dimethyl-1,6-octadiene; 1,3-cyclopentadiene; 1,4-cyclohexadiene; vinyl norbornene (VNB); dicyclopendadiene (DCPD); and combinations thereof. For example, the diene is ENB or VNB. For example, the ethylene-propylene-diene terpolymer comprises an ENB content of from 0.5 wt % to 8 wt % based on the weight of the terpolymer, or from 2 wt % to 6 wt %, or from 3 wt % to 5 wt %. For example, the ethylene-propylene-diene terpolymer comprises an ENB content of from 0.5 wt % to 3 wt %.

The ethylene-propylene-diene terpolymer may have a propylene amount of from 65 wt % to 95 wt %, or from 70 wt % to 95 wt %, or from 75 wt % to 95 wt %, or from 80 wt % to 95 wt %, or from 83 wt % to 95 wt %, or from 84 wt % to 95 wt %, or from 84 wt % to 94 wt %, or from 72 wt % to 95 wt %, or from 80 wt % to 93 wt %, or from 85 wt % to 89 wt %, based on the weight of the polymer. The balance of the ethylene-propylene-diene terpolymer comprises at least one of ethylene and C₄-C₂₀ α-olefin and one or more dienes. The α-olefin may be ethylene, butene, hexane, or octene. When two or more α-olefins are present in the polymer, ethylene and at least one of butene, hexane, or octene may be used.

In some embodiments, the ethylene-propylene-diene terpolymer comprises from 2 to 30 wt % of C₂ and/or C₄-C₂₀ α-olefins based the weight of the ethylene-propylene-diene terpolymer. When two or more of ethylene and C₄-C₂₀ α-olefins are present the combined amounts of these olefins in the polymer can be at least 2 wt % and falling within the ranges described herein. Other ranges of the amount of ethylene and/or one or more α-olefins may include from 2 wt % to 15 wt %, or from 5 wt % to 15 wt %, or from 8 wt % to 15 wt %, or from 8 to 12 wt %, based on the weight of the ethylene-propylene-diene terpolymer.

In some embodiments, the ethylene-propylene-diene terpolymer comprises an ethylene content of from 5 wt % to 25 wt % based on the weight of the terpolymer, or from 8 wt % to 12 wt %.

In some embodiments, the ethylene-propylene-diene terpolymer comprises a diene content of from 1 wt % to 16 wt % based on the weight of the terpolymer, or from 1 wt % to 12 wt %, or 2 wt % to 6 wt %, or from 2 wt % to 6 wt %.

In at least one embodiment, the ethylene-propylene-diene terpolymer is halogenated. The ethylene-propylene-diene terpolymer may be halogenated by methods known in the art or by methods described in U.S. Pat. No. 4,051,083.

In at least one embodiment, the synthesis of the ethylene-propylene-diene terpolymer utilizes a bis((4-triethylsilyl)phenyl)methylene (cyclopentadienyl) (2,7-di-tert-butyl-fluoren-9-yl) hafnium dimethyl catalyst precursor. However, other metallocene precursors with good diene incorporation and MW capabilities could also be used. The synthesis of the ethylenepropylene-diene terpolymer also utilizes a dimethylanilinium tetrakis(pentafluorophenyl) borate activator but dimethylaniliniumtetrakis(heptafluoronaphthyl) borate and other non-coordinating anion type activators or MAO could also be used.

In a reactor, a copolymer material is produced in the presence of ethylene, propylene, ethylidene norbornene, and a catalyst comprising the reaction product of N,Ndimethylanilinium tetrakis(pentafluorophenyl) borate and [cyclopentadienyl(2,7-di-tbutylfluorenyl)di-p-triethylsilanephenylmethane] hafnium dimethyl. The copolymer solution emerging from the reactor is quenched and then devolatilized using conventionally known devolatilization methods, such as flashing or liquid phase separation, first by removing the bulk of the isohexane to provide a concentrated solution, and then by stripping the remainder of the solvent in anhydrous conditions using a devolatilizer so as to end up with a molten polymer composition containing less than 0.5 wt % of solvent and other volatiles. The molten polymer composition was advanced by a screw to a pelletizer from which the ethylene-propylene-diene terpolymer composition pellets are submerged in water and cooled until solid.

The ethylene-propylene-diene terpolymer may have a melt flow rate (MFR, 2.16 kg weight at 230° C.), equal to or greater than 0.1 g/10 min as measured according to the ASTM D-1238-13. In some embodiments, the MFR (2.16 kg at 230° C.) is from 0.5 g/10 min to 200 g/10 min, or from 0.5 g/10 min to 100 g/10 min, or from 0.5 g/10 min to 30 g/10 min, or from 0.5 g/10 min to 10 g/10 min, or from 0.5 g/10 min to 5 g/10 min, or from 0.5 g/10 min to 2 g/10 min, or from 0.1 g/10 min to 15 g/10 min.

The ethylene-propylene-diene terpolymer may have a heat of fusion (Hf) determined by the DSC procedure described herein, which is greater than or equal to 0 Joules per gram (J/g), and is equal to or less than 80 J/g, or equal to or less than 75 J/g, or equal to or less than 70 J/g, or equal to or less than 60 J/g, or equal to or less than 50 J/g, or equal to or less than 35 J/g. In some embodiments, the Hf is 0 J/g.

The crystallinity of the ethylene-propylene-diene terpolymer may be expressed in terms of percentage of crystallinity (e.g., % crystallinity), as determined according to the DSC procedure described herein. The ethylene-propylene-diene terpolymer may have a % crystallinity of from 0% to 40%. In some embodiments, the % crystallinity is 0%. The ethylene-propylenediene terpolymer may have a single broad melting transition. However, the ethylene-propylene-diene terpolymer may show secondary melting peaks adjacent to the principal peak, but for purposes herein, such secondary melting peaks are considered together as a single melting point, with the highest of these peaks (relative to baseline as described herein) being considered as the melting point of the ethylene-propylene-diene terpolymer.

The Differential Scanning calorimetry (DSC) procedure may be used to determine heat of fusion and melting temperature of the ethylene-propylene-diene terpolymer. The method is as follows: approximately 6 mg of material placed in microliter aluminum sample pan. The sample is placed in a Differential Scanning calorimeter (Perkin Elmer Pyris 1 Thermal Analysis System) and is cooled to −80° C. The sample is heated at 10° C./min to attain a final temperature of 120° C. The sample is cycled twice. The thermal output, recorded as the area under the melting peak of the sample, is a measure of the heat of fusion and may be expressed in Joules per gram of polymer and is automatically calculated by the Perkin Elmer System. The melting point is recorded as the temperature of the greatest heat absorption within the range of melting of the sample relative to a baseline measurement for the increasing heat capacity of the polymer as a function of temperature.

The ethylene-propylene-diene terpolymer may be a blend of discrete random ethylene-propylene-diene terpolymers as long as the polymer blend has the properties of the ethylene-propylene-diene terpolymer as described herein. The number of ethylene-propylenediene terpolymers may be three or less, or two or less. In one or more embodiments, the ethylene-propylene-diene terpolymer may include a blend of two ethylene-propylene-diene terpolymers differing in the olefin content, the diene content, or the both.

In at least one embodiment, the ethylene-propylene-diene terpolymer is functionalized with sulfur.

In another embodiment, the ethylene-propylene-diene terpolymer is functionalized with sulfur and an activator. In a further embodiment, the activator is zinc oxide or stearic acid. In a further embodiment, the activator is a combination of zinc oxide and stearic acid.

In another embodiment, the ethylene-propylene-diene terpolymer is functionalized with sulfur and a silane coupling agent. In a further embodiment, the silane coupling agent is bis(3-triethoxysilylpropyl)tetrasulphide (TESPT) (available as Si69® from Evonik Industries) and bis[3-(diethoxy octyloxysilyl)propyl]tetrasulfide (from Shin-Etsu).

In another embodiment, the ethylene-propylene-diene terpolymer 5 is functionalized with sulfur, an activator and a silane coupling agent.

In another embodiment, the ethylene-propylene-diene terpolymer is functionalized with sulfur and a vulcanizing accelerator. In a further embodiment, the vulcanizing accelerator is n-tertiary-butyl-2-benzothiazyl sulfenamide (TBBS).

The compositions may include the ethylene-propylene-diene terpolymer in an amount of from 5 phr to 30 phr, or from 5 phr to 25 phr, or from 10 phr to 20 phr.

### Poly(Isobutylene-Co-Para-Methylstyrene-Co-Isoprene) Terpolymers

The term “poly(isobutylene-co-para-methylstyrene-co-isoprene) terpolymer” as used in the specification means a terpolymer comprising isobutylene, para-methylstyrene and isoprene polymers.

The poly(isobutylene-co-para-methylstyrene-co-isoprene) terpolymers (IB-IPPMS) are prepared as described in U.S. Pat. No. 6,960,632 or as described herein. Poly(isobutylene-co-para-methylstyrene-co-isoprene) terpolymer is prepared by adding an initiator/co-initiator solution to a mixed para-methyl styrene, isoprene, and isobutylene monomer solution using standard slurry cationic polymerization techniques. In an embodiment, the poly(isobutylene-co-para-methylstyrene-co-isoprene) terpolymer may be halogenated.

In at least one embodiment, the poly(isobutylene-co-para-methylstyrene-co-isoprene) terpolymer contains from 4-8 mol % p-methylstyrene, 0.2-2 mol % isoprene and 90-95 mol % isobutylene based on the terpolymer.

In at least one embodiment, the poly(isobutylene-co-para-methylstyrene-co-isoprene) terpolymer is functionalized with sulfur.

In another embodiment, the poly(isobutylene-co-para-methylstyrene-co-isoprene) terpolymer is functionalized with sulfur and an activator. In a further embodiment, the activator is zinc oxide or stearic acid. In a further embodiment, the activator is a combination of zinc oxide and stearic acid.

In another embodiment, the poly(isobutylene-co-para-methylstyrene-co-isoprene) terpolymer is functionalized with sulfur and a silane coupling agent. In a further embodiment, the silane coupling agent is bis(3-triethoxysilylpropyl)tetrasulphide (TESPT) (available as Si69® from Evonik Industries) and bis[3-(diethoxy octyloxysilyl)propyl]tetrasulfide (from Shin-Etsu).

In another embodiment, the poly(isobutylene-co-para-methylstyrene-co-isoprene) terpolymer is functionalized with sulfur, an activator and a silane coupling agent.

In another embodiment, the poly(isobutylene-co-para-methylstyrene-co-isoprene) terpolymer is functionalized with sulfur and a vulcanizing accelerator. In a further embodiment, the vulcanizing accelerator is n-tertiary-butyl-2-benzothiazyl sulfenamide (TBBS).

The compositions may include the poly(isobutylene-co-paramethylstyrene-co-isoprene) terpolymer in an amount of from 5 phr to 30 phr, or from 5 phr to 25 phr, or from 10 phr to 20 phr.

### Carbon Material

An additive of a composition of the present disclosure may be a carbon material. The carbon may be any size and range, for example in the tire industry, from 0.0001 μm to 100 μm.

In at least one embodiment, the composition comprises, per 100 parts by weight of rubber (phr), about 50 to 80 phr filler. In another embodiment, the composition comprises, per 100 parts by weight of rubber (phr), about 65 to 75 phr carbon.

All carbon blacks, in particular blacks of the HAF, ISAF or SAF type, conventionally used in tires (“tire-grade” blacks) are suitable as carbon blacks. Mention will more particularly be made, among the latter, of the reinforcing carbon blacks of the 100, 200 or 300 series (ASTM grades), such as, for example, the N115, N134, N234, N326, N330, N339, N347 or N375 blacks, or also, depending on the applications targeted, the blacks of higher series (for example, N660, N683 or N772). The carbon blacks might, for example, be already incorporated in the isoprene elastomer in the form of a masterbatch (see, for example, International Applications WO 97/36724 or WO 99/16600). In some embodiments, the carbon black is Vulcan®3 N330 from Cabot Corp.

### Plasticizer

An additive of a composition of the present disclosure may be a plasticizer. As used herein, the term “plasticizer” (also referred to as a processing oil), refers to a petroleum derived processing oil and synthetic plasticizer. Such oils are primarily used to improve the processability of the composition. Suitable plasticizers include, but are not limited to, aliphatic acid esters or hydrocarbon plasticizer oils such as paraffinic oils, aromatic oils, naphthenic petroleum oils, and polybutene oils. A plasticizer may be naphthenic oil, which is commercially available by Nynas under the trade name Nytex™ 4700.

MES and TDAE oils are described in KGK (Kautschuk Gummi Kunstoffe), 52nd year, No. 12/99, pp. 799-805, entitled “Safe Process Oils for Tires with Low Environmental Impact”. Examples of MES oils (whether “extracted” or “hydrotreated”) and TDAE oils are sold under the names Flexon™ 683 by ExxonMobil, Vivatec™ 200 or Vivatec™ 500 by H&R European, Plaxolene™ MS by Total, or Catenex™ SNR by Shell.

“Triester” and “fatty acid” refers to a mixture of triesters or a mixture of fatty acids, respectively. A fatty acid is constituted majoritarily (greater than 50%, or more specifically, greater than 80% by weight) of an unsaturated Ci8 fatty acid. For example, fatty acids include oleic acid, linoleic acid, linolenic acid and mixtures thereof. Whether synthetic or natural in origin, fatty acids constitute more that 50% by weight and more than 80% by weight of oleic acid.

Further, glycerol trioleate, derived from oleic acid and glycerol, can be used. Examples of glycerol trioleates include vegetable oils sunflower oil or rapeseed oil having a high content of oleic acid (more than 50%, and more than 80% by weight).

The glycerol triester can be used in an amount of 5 to 80 phr, such as 10 to 50 phr, such as 15 to 30 phr, in particular when the tread of the present disclosure is intended for a passenger-type vehicle. In the light of the present description, the person skilled in the art will be able to adjust this amount of ester as a function of the specific conditions of embodiment of the present disclosure, in particular the amount of inorganic filler used.

Resins formed of C₅ fraction/vinylaromatic copolymer, in particular of C₅ fraction/styrene or C₅ fraction/C₉ fraction copolymer can be used as tackifiers for adhesives and paints, but are also useful as processing aids in tire tread compositions.

A C₅ fraction/vinylaromatic copolymer can be a copolymer of a vinylaromatic monomer and of a C₅ fraction. Styrene, alpha-methylstyrene, ortho-, meta- or para-methylstyrene, vinyltoluene, para-(tert-butyl) styrene, methoxystyrenes, chlorostyrenes, vinylmesitylene, divinylbenzene, vinylnaphthalene and any vinylaromatic monomer resulting from a C₉ fraction (or more generally from a C₅ to C₁₀ fraction), for example, are suitable as vinylaromatic monomers. The vinylaromatic compound is styrene or a vinylaromatic monomer resulting from a C₉ fraction (or more generally from a C₅ to C₁₀ fraction).

The term C₅ fraction (or, for example, Co fraction respectively) means any fraction resulting from a process resulting from petrochemistry or from the refining of petroleum, any distillation fraction predominantly comprising compounds having 5 (or respectively 9, in the case of a C₉ fraction) carbon atoms. By way of example C₅ fractions can comprise the following compounds, the relative proportions of which can vary according to the process by which they are obtained: 1,3-butadiene, l-butene, 2-butenes, 1,2-butadiene, 3-methyl-1-butene, 1,4-pentadiene, 1-pentene, 2-methyl-1-butene, 2-pentenes, isoprene, cyclopentadiene, which can be present in the form of its dicyclopentadiene dimer, piperylenes, cyclopentene, 1-methylcyclopentene, 1-hexene, methylcyclopentadiene or cyclohexene. These fractions can be obtained by chemical processes known in the petroleum industry and petrochemistry. Processes for the steam cracking of naphtha or processes for the fluid catalytic cracking of gasolines can be combined with chemical treatments to convert these fractions including, but not limited to, hydrogenation and dehydrogenation.

The plasticizing hydrocarbon resins can be homopolymers or copolymers of cyclopentadiene (CPD) or dicyclopentadiene (DCPD), homopolymers or copolymers of terpene, homopolymers or copolymers of terpene, homopolymers or copolymers of C cut and mixtures thereof. Such copolymer plasticizing hydrocarbon resins include, for example, resins made up of copolymers of (D) CPD/vinyl-aromatic, of (D) CPD/terpene, of (D) CPD/C cut, of terpene/vinyl-aromatic, of C₅ cut/vinyl-aromatic and of combinations thereof.

Terpene monomers useful for the terpene homopolymer and copolymer resins include alpha-pinene, beta-pinene and limonene, and polymers of the limonene monomers that include three isomers: the L-limonene (laevorotatory enantiomer); the D-limonene (dextrorotatory enantiomer); and dipentene, a racemic mixture of the dextrorotatory and laevorotatory enantiomers.

Examples of vinyl aromatic monomers include styrene, alpha-methylstyrene, ortho-, meta-, para-methylstyrene, vinyl-toluene, para-tertiobutylstyrene, methoxy styrenes, chloro-styrenes, vinyl-mesitylene, divinylbenzene, vinylnaphthalene, any vinyl-aromatic monomer coming from the C₉ cut (or, more generally, from a C₅ to C₁₀ cut), including a vinyl-aromatic copolymer include the vinyl-aromatic in the minority monomer, expressed in molar fraction, in the copolymer.

Plasticizing hydrocarbon resins include (D) CPD homopolymer resins, the (D) CPD/styrene copolymer resins, the polylimonene resins, the (D) CPD/styrene copolymer resins, the polylimonene resins, the limonene/styrene copolymer resins, the limonene/D (CPD) copolymer resins, C₅ cut/styrene copolymer resins, C₅ cut/C₉ cut copolymer resins, and mixtures thereof.

### Antioxidant

An additive of a composition of the present disclosure may be an antioxidant. As used herein, the term “antioxidant” refers to a chemical that combats oxidative degradation. Suitable antioxidants include diphenyl-p-phenylenediamine and those disclosed in The Vanderbilt Rubber Handbook (1978), Pages 344 to 346. A useful antioxidant is para-phenylenediamines, which is commercially available by Eastman under the trade name Santoflex™ 6PPD (N-(1,3-Dimethylbutyl)-N′-phenyl-1,4-phenylenediamine).

### Diene Elastomer

Compositions of the present disclosure can also include an elastomer. For example, a composition can include 5% to 75% elastomer by weight of the composition. Suitable elastomers include, for example, diene elastomers.

“Diene elastomer” can be an elastomer resulting at least in part (homopolymer or copolymer) from diene monomers (monomers bearing two double carbon-carbon bonds, whether conjugated or not).

A diene elastomer can be “highly unsaturated,” resulting from conjugated diene monomers, which have a greater than 50% molar content of units.

According to one aspect, each diene elastomer has a glass transition temperature (Tg) from −75° C. to −40° C. A diene can be a styrenebutadiene copolymer, natural polyisoprene, synthetic polyisoprene having a cis-1,4 linkage content greater than 95%, styrene/butadiene/isoprene terpolymer, or a mixture of these elastomers. According to one aspect, each diene elastomer has a glass transition temperature (Tg) from −75° C. to −40° C., or each diene elastomer has a Tg from −110° C. to −75° C., such as from −100° C. to −80° C., and is selected from polybutadienes having a cis-1,4 linkage content greater than 90% and isoprene/butadiene copolymers comprising butadiene units in an amount equal to or greater than 50%.

In another aspect, each diene elastomer having a Tg from −75° C. to −40° C. is selected from the group consisting of natural polyisoprenes and synthetic polyisoprenes having a cis-1,4 linkage content greater than 95%, and each diene elastomer having a Tg from −110° C. to −75° C. is a polybutadiene having a cis-1,4 linkage content greater than 90%.

In at least one embodiment, the composition comprises a blend of the diene elastomer(s) having a Tg from −75° C. to −40° C. and the diene elastomer(s) having a Tg from −110° C. to −75° C.

In at least one aspect, the composition includes a blend of at least one of the polybutadienes having a cis-1,4 linkage content greater than 90% with at least one of the natural or synthetic polyisoprenes (having a cis-1,4 linkage content greater than 95%).

In another aspect, the composition includes a blend of at least one of the polybutadienes having a cis-1,4 linkage content greater than 90% with at least one of the terpolymers of styrene, isoprene and butadiene.

These diene elastomers can be classified into two categories: “essentially unsaturated” or “essentially saturated”. The term “essentially unsaturated” is understood to mean generally a diene elastomer resulting at least in part from conjugated diene monomers having a level of units of diene origin (conjugated dienes) which is greater than 15% (mol %); thus it is that diene elastomers such as butyl rubbers or copolymers of dienes and of alpha-olefins of EPDM type do not come within the preceding definition and can in particular be described as “essentially saturated” diene elastomers (low or very low level of units of diene origin, less than 15%). In the category of “essentially unsaturated” diene elastomers, the term “highly unsaturated” diene elastomer is understood to mean in particular a diene elastomer having a level of units of diene origin (conjugated dienes) which is greater than 50%.

Given these definitions, the term diene elastomer capable of being used herein is understood more particularly to mean: (a) a homopolymer obtained by polymerization of a conjugated diene monomer having from 4 to 12 carbon atoms; (b) a copolymer obtained by copolymerization of one or more conjugated dienes with one another or with one or more vinylaromatic compounds having from 8 to 20 carbon atoms; (c) a ternary copolymer obtained by copolymerization of ethylene and of an alpha-olefin having 3 to 6 carbon atoms with a non-conjugated diene monomer having from 6 to 12 carbon atoms, such as, for example, the elastomers obtained from ethylene and propylene with a non-conjugated diene monomer of the abovementioned type, such as, in particular, 1,4-hexadiene, ethylidenenorbornene or dicyclopentadiene; (d) a copolymer of isobutene and of isoprene (butyl rubber) and also the halogenated versions, in particular chlorinated or brominated versions, of this type of copolymer.

The following are suitable in particular as conjugated dienes: 1,3-butadiene, 2-methyl-1,3-butadiene, 2,3-di(C₁-C₅ alkyl)-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, an aryl-1,3-butadiene, 1,3-pentadiene or 2,4-hexadiene. The following, for example, are suitable as vinylaromatic compounds: styrene, ortho-, meta- or para-methylstyrene, the “vinyltoluene” commercial mixture, para-(tert-butyl) styrene, methoxystyrenes, chlorostyrenes, vinylmesitylene, divinylbenzene or vinylnaphthalene.

The copolymers can include from 99% to 20% by weight of diene units and from 1% to 80% by weight of vinylaromatic units. The elastomers may have any microstructure which depends on the polymerization conditions used, in particular on the presence or absence of a modifying and/or randomizing agent and on the amounts of modifying and/or randomizing agent employed. The elastomers can, for example, be block, random, sequential or microsequential elastomers and can be prepared in dispersion or in solution; they can be coupled and/or star-branched or also functionalized with a coupling and/or star-branching or functionalization agent. Mention may be made, for coupling to carbon black, for example, of functional groups comprising a C—Sn bond or aminated functional groups, such as benzophenone, for example.

The following are suitable: polybutadienes, in particular those having a content (molar %) of 1,2-units of from 4% to 80% or those having a content (molar %) of cis-1,4-units of greater than 80%, polyisoprenes, butadiene/styrene copolymers and in particular those having a Tg (glass transition temperature, measured according to Standard ASTM D3418) of from 0° C. to −70° C. and more particularly from −10° C. to −60° C., a styrene content of from 5% to 60% by weight and more particularly from 20% to 50%, a content (molar %) of 1,2-bonds of the butadiene part of from 4% to 75% and a content (molar %) of trans-1,4-bonds of from 10% to 80%, butadiene/isoprene copolymers, in particular those having an isoprene content of from 5% to 90% by weight and a Tg of −40° C. to −80° C., or isoprene/styrene copolymers, in particular those having a styrene content of from 5% to 50% by weight and a Tg of from −25° C. to −50° C. In the case of butadiene/styrene/isoprene copolymers, those having a styrene content of from 5% to 50% by weight and more particularly of from 10% to 40%, an isoprene content of from 15% to 60% by weight and more particularly from 20% to 50%, a butadiene content of from 5% to 50% by weight and more particularly of from 20% to 40%, a content (molar %) of 1,2-units of the butadiene part of from 4% to 85%, a content (molar %) of trans-1,4-units of the butadiene part of from 6% to 80%, a content (molar %) of 1,2-plus 3,4-units of the isoprene part of from 5% to 70% and a content (molar %) of trans-1,4-units of the isoprene part of from 10% to 50%, and more generally a butadiene/styrene/isoprene copolymer having a Tg of from −20° C. to −70° C., are suitable.

The diene elastomer chosen from the group of the highly unsaturated diene elastomers of polybutadienes (abbreviated to “BR”), synthetic polyisoprenes (IR), natural rubber (NR), butadiene copolymers, isoprene copolymers or mixture(s) of these elastomers. Such copolymers are may be chosen from the group of butadiene/styrene copolymers (SBR), isoprene/butadiene copolymers (BIR), isoprene/styrene copolymers (SIR), isoprene/butadiene/styrene copolymers (SBIR), or combination(s) thereof.

In at least one embodiment, the diene elastomer is predominantly (i.e., for more than 50 wt %) an SBR, whether an SBR prepared in emulsion (“ESBR”) or an SBR prepared in solution (“SSBR”), or an SBR/BR, SBR/NR (or SBR/IR), BR/NR (or BR/IR) or also SBR/BR/NR (or SBR/BR/IR) blend (mixture). In the case of an SBR (ESBR or SSBR) elastomer, use is made in particular of an SBR having a moderate styrene content, for example of from 20% to 35% by weight, or a high styrene content, for example from 35 to 45%, a content of vinyl bonds of the butadiene part of from 15% to 70%, a content (molar %) of trans-1,4-bonds of from 15% to 75% and a Tg of from −10° C. to −55° C.; such an SBR can advantageously be used as a mixture with a BR which may have more than 90% (molar %) of cis-1,4-bonds.

The term “isoprene elastomer” is understood to mean, in a known way, an isoprene homopolymer or copolymer, in other words a diene elastomer chosen from the group consisting of natural rubber (NR), synthetic polyisoprenes (IR), the various copolymers of isoprene and the mixtures of these elastomers. Mention will in particular be made, among isoprene copolymers, of isobutene/isoprene copolymers (butyl rubber IM), isoprene/styrene copolymers (SIR), isoprene/butadiene copolymers (BIR) or isoprene/butadiene/styrene copolymers (SBIR). This isoprene elastomer can be natural rubber or a synthetic cis-1,4-polyisoprene. For example, among these synthetic polyisoprenes, of the polyisoprenes having a level (molar %) of cis-1,4-bonds of greater than 90%, such as still of greater than 98%.

According to still another aspect, the rubber composition includes a blend of one or more “high Tg” diene elastomer exhibiting a Tg of from −70° C. to 0° C. and of one or more “low Tg” diene elastomer exhibiting a Tg of from −110° C. to −80° C., such as from −100° C. to −90° C. The high Tg elastomer can be chosen from the group of S-SBRs, E-SBRs, natural rubber, synthetic polyisoprenes (exhibiting a level (molar %) of cis-1,4-structures such as cis-1,4-structures of greater than 95%), BIRs, SIRS, SBIRs and the mixtures of these elastomers. The low Tg elastomer can include butadiene units according to a level (molar %) at least equal to 70%. The elastomer can include a polybutadiene (BR) exhibiting a level (molar %) of cis-1,4-structures of greater than 90%.

According to another embodiment of the present disclosure, the rubber composition comprises, for example, from 30 to 100 phr, such as from 50 to 100 phr (parts by weight per hundred parts of total elastomer), of a high Tg elastomer as a blend with 0 to 70 phr, such as from 0 to 50 phr, of a low Tg elastomer. According to another example, the composition includes, for the whole of the 100 phr, one or more SBR(s) prepared in solution.

According to another embodiment of the present disclosure, the diene elastomer of the composition according to the present disclosure comprises a blend of a BR (as low Tg elastomer) exhibiting a level (molar %) of cis-1,4-structures of greater than 90% with one or more S-SBRs or E-SBRs (as high Tg elastomer(s)).

The compositions described herein can include a single diene elastomer or a mixture of several diene elastomers, it being possible for the diene elastomer or elastomers to be used in combination with any type of synthetic elastomer other than a diene elastomer, indeed even with polymers other than elastomers, for example thermoplastic polymers.

The compositions can include from 5 or 10 wt % to 15 or 20 or 25 wt %, by weight of the composition of the propylene-ethylene-diene terpolymer which is a propylene-α-olefin elastomer. Such elastomers are described in, for example, U.S. Pat. Nos. 7,390,866 and 8,013,093, and are sold under such names as Vistamaxx™ Tafmer™, and Versify™. Generally, these are random polypropylene copolymers having from 5 to 25 wt % ethylene or butene-derived comonomer units having limited isotactic sequences to allow for some level of crystallinity, the copolymers in some embodiments, having a weight average molecular weight of from 10,000 or 20,000 g/mole to 100,000 or 200,000 or 400,000 g/mole and a melting point (DSC) of less than 110 or 100° C.

In at least one embodiment, the tire tread composition does not include 4 to 20 wt % of a polyolefin-polybutadiene block-copolymer, wherein the polyolefin-polybutadiene block-copolymer is a block copolymer having the general formula: PO-XL-fPB; where “PO” is a polyolefin block having a weight average molecular weight within the range from 1000 to 150,000 g/mol, the “fPB” is a functionalized polar polybutadiene block having a weight average molecular weight of from 500 to 30,000 g/mol, and “XL” is a crosslinking moiety that covalently links the PO and fPB blocks; and wherein the Maximum Energy Loss (Tangent Delta) of the immiscible polyolefin domain is a temperature within the range from −30° C. to 10° C.

In some embodiments, a styrenic copolymer in a composition is a styrene-butadiene block copolymer “rubber.” Such rubbers may have from 10 or 15 or 20 wt % to 30 or 25 or 40 wt % styrene derived units, by weight of the block copolymer, and from 30 or 40 or 45 wt % to 55 or 60 or 65 wt % vinyl groups.

### Tires

A tire (also referred to as a “tire product” herein) can be any suitable tire, such as a rubber tire having an outer (visible) rubber sidewall layer where the outer sidewall layer includes a composition of the present disclosure.

The tire can be built, shaped, molded to include the outer sidewall rubber sidewall layer and cured by various methods which will be readily apparent to those having skill in such art.

The prepared tire of the present disclosure can be conventionally shaped and cured by methods known to those having skill in such art.

### Inorganic Fillers

Because a need for filler to be introduced to the ultimate tire product is reduced or eliminated using methods of the present disclosure, the reduction or absence of filler in the tire product provides improved wear resistance, for example reduced or eliminated cracking initiation and propagation, of the tire product (tire tread).

The term “filler” as used herein refers to any material that is used to reinforce or modify physical properties of a composition (as a tire product), impart certain processing properties, or reduce cost of a composition.

Examples of inorganic filler include calcium carbonate, clay, mica, silica, silicates, talc, titanium dioxide, alumina, zinc oxide, starch, wood flour, or combination(s) thereof. The fillers may be any size and range, for example in the tire industry, from 0.0001 μm to 100 μm.

As used herein, the term “silica” is meant to refer to any type or particle size silica or another silicic acid derivative, or silicic acid, processed by solution, pyrogenic, or the like methods, including untreated, precipitated silica, crystalline silica, colloidal silica, aluminum or calcium silicates, fumed silica, and the like. Precipitated silica can be conventional silica, semi-highly dispersible silica, or highly dispersible silica. A filler can be commercially available by Rhodia Company under the trade name ZEOSIL™ Z1165 or ZEOSIL™ 1165 MP.

In some embodiments, a composition (as a tire product) includes, per 100 parts by weight of rubber (phr), about 100 to about 140 phr silica. In another embodiment, a composition (as a tire product) includes, per 100 parts by weight of rubber (phr), about 110 to about 130 phr of silica. In a further embodiment, a composition includes, per 100 parts by weight of rubber (phr), about 115 to about 120 phr silica.

### Additional Aspects

The present disclosure provides, among others, the following aspects, each of which may be considered as optionally including any alternate aspects.

Clause 1. A method of forming a functionalized polymer, the method comprising:
introducing a polymer and a coupling agent to an extruder at a feed throat of the extruder; and
extruding the polymer and the coupling agent through at least a portion of the extruder via a plurality of intermeshing screws disposed within the extruder to form the functionalized polymer,
wherein at least one screw of the plurality of intermeshing screws has a first mixing zone having a total length of about 4 L/D to about 6 L/D, a second mixing zone having a total length of 2.5 L/D to 3.5 L/D, and a third mixing zone having a total length of about 2.5 L/D to about 4.5 L/D,
wherein the first mixing zone is a mixing zone closest to the feed throat of the extruder, the second mixing zone is disposed downstream of the first mixing zone relative to the feed throat, and the third mixing zone is disposed downstream of the second mixing zone relative to the feed throat.
   Clause 2. The method of Clause 1, wherein the at least one screw has:
a fourth flow zone having one or more conveying elements and is disposed between the first mixing zone and the second mixing zone, and
a fifth flow zone having one or more conveying elements and is disposed between the second mixing zone and the third mixing zone.
   Clause 3. The method of Clause 1 or 2, wherein each of the first mixing zone, the second mixing zone, and the third mixing zone have one or more left handed (forward) kneading blocks and one or more neutral convey kneading blocks.
   Clause 4. The method of any of Clauses 1 to 3, wherein the first mixing zone has a total length of about 5 L/D.
   Clause 5. The method of any of Clauses 1 to 4, wherein the first mixing zone has a ratio of total length of the one or more left handed (forward) kneading blocks of the first mixing zone to total length of the one or more neutral convey kneading blocks of the first mixing zone of about 0.5 to about 0.75.
   Clause 6. The method of any of Clauses 1 to 5, wherein the ratio of the first mixing zone is about 0.67.
   Clause 7. The method of any of Clauses 1 to 6, wherein the second mixing zone has a total length of about 3 L/D.
   Clause 8. The method of any of Clauses 1 to 7, wherein the second mixing zone has a ratio of total length of the one or more left handed (forward) kneading blocks of the second mixing zone to total length of the one or more neutral convey kneading blocks of the second mixing zone of about 0.8 to about 2.
   Clause 9. The method of any of Clauses 1 to 8, wherein the ratio is about 1 to about 1.3.
   Clause 10. The method of any of Clauses 1 to 9, wherein the third mixing zone has a ratio of total length of the one or more left handed (forward) kneading blocks of the third mixing zone to total length of the one or more neutral convey kneading blocks of the third mixing zone of about 0.5 to about 2.5.
   Clause 11. The method of any of Clauses 1 to 10, wherein introducing the polymer and the coupling agent to the feed throat comprises introducing the polymer and the coupling agent to an initial flow zone of the at least one screw upstream of the first mixing zone, the initial flow zone having one or more conveying elements.
   Clause 12. The method of any of Clauses 1 to 11, wherein extruding the polymer and the coupling agent through the at least a portion of the extruder comprises extruding the polymer and the coupling agent from the initial flow zone to the first mixing zone, and the first mixing zone begins at about 0.8× to about 1.2× length of a longest mixing zone of the at least one screw.
   Clause 13. The method of any of Clauses 1 to 12, wherein the at least one screw has a distance between the first mixing zone and the second mixing zone of about 0.3× to 2× length of a longest mixing zone of the screw.
   Clause 14. The method of any of Clauses 1 to 13, wherein the distance between the first mixing zone and the second mixing zone is about 0.6× to about 1×.
   Clause 15. The method of any of Clauses 1 to 14, wherein the at least one screw has a distance between the second mixing zone and the third mixing zone of about 0.0.15× to about 1.5× length of the longest mixing zone of the screw.
   Clause 16. The method of any of Clauses 1 to 15, wherein the at least one screw further comprises a fourth mixing zone comprising one or more forward (left handed) kneading blocks and one or more neutral convey kneading blocks, the fourth mixing zone disposed downstream of the third mixing zone relative to the feed throat of the extruder.
   Clause 17. The method of any of Clauses 1 to 16, wherein the fourth mixing zone has a total length of about 4 L/D to about 6 L/D.
   Clause 18. The method of any of Clauses 1 to 17, wherein the fourth mixing zone has a ratio of total length of the one or more left handed (forward) kneading blocks of the fourth mixing zone to total length of the one or more neutral convey kneading blocks of the fourth mixing zone of about 0.5 to about 1.
   Clause 19. The method of any of Clauses 1 to 18, wherein the ratio is about 0.67.
   Clause 20. The method of any of Clauses 1 to 19, wherein the at least one screw has a distance between the third mixing zone and the fourth mixing zone of about 0.2× to about 1.7× length of a longest mixing zone of the screw.
   Clause 21. The method of any of Clauses 1 to 20, further comprising introducing additives to the extruder to form a composition comprising the additives and the functionalized polymer.
   Clause 22. The method of any of Clauses 1 to 21, wherein extruding the polymer and the coupling agent through the at least a portion of the extruder is performed at an average extruder temperature of about 200° F. to about 300° F.
   Clause 23. The method of any of Clauses 1 to 22, wherein extruding the polymer and the coupling agent through the at least a portion of the extruder is performed by rotating the at least one screw of the plurality of screws at a rate of about 0 rpm to about 375 rpm, such as about 275 rpm to about 375 rpm.
   Clause 24. The method of any of Clauses 1 to 23, wherein the polymer is selected from the group consisting of a butyl rubber, an ethylene-propylene-diene terpolymer, a poly(isobutylene-co-para-methylstyrene-co-isoprene) terpolymer, and combination(s) thereof.
   Clause 25. The method of any of Clauses 1 to 24, wherein the functionalized polymer is selected from the group consisting of a functionalized butyl rubber, a functionalized ethylene-propylene-diene terpolymer, a functionalized poly(isobutylene-co-para-methylstyrene-co-isoprene) terpolymer, and combination(s) thereof.
   Clause 26. The method of any of Clauses 1 to 25, wherein the coupling agent is selected from the group consisting of:
bis[3-(triethoxysilyl)propyl]polysulfide,
bis[3-(methyl diethoxysilyl)propyl]polysulfide,
bis[3-(octyl diethoxysilyl)propyl]polysulfide,
bis[3-(diethoxy octyloxysilyl)propyl]polysulfide,
bis[3-(ethoxy dioctyloxysilyl)propyl]polysulfide,
bis[8-(triethoxysilyl)octyl]polysulfide,
bis[8-(methyl diethoxysilyl)octylpolysulfide, and
combination(s) thereof.
   Clause 27. The method of any of Clauses 1 to 26, wherein the coupling agent is elemental sulfur.

### EXAMPLES

### ¹H-NMR Test Method

In a glass vial, add 50 mg of sample and ˜1 mL of 99.8% CDCl₃ with 0.03% (v/v) TMS. The glass vial was placed on a wrist action shaker until completely dissolved ˜2 hours. The solution was transferred to a new NMR tube (using Deuterotubes BORO400-5-7) ensuring that all of the sample was dissolved and there were no solids remaining. The proton spectrum was acquired on the Bruker 500 MHz NMR locked onto CDCl₃ as the solvent and using the following parameters: NUC: 1H; DS: 2; NS: 16; TDO: 1; AQ: 3.27 seconds; SW: 19.99 ppm or 10,000 Hz; Zg30 is a 30° pulse; 5 mm probe, 16 scans, 1 s delay, 500 MHz.

The spectra were analyzed using MestReNova software. A manual phase correction and baseline correction before integration was performed.

A lab extruder was utilized to demonstrate the feasibility of a reactive extrusion process for the sulfur functionalization of EPDM & butyl rubbers. These functionalized polymers were blended into a tire tread compound to demonstrate the improved performance of the functionalized polymers.

### Masterbatch (MB)

EPDM and Butyl masterbatches (MBs) were made in a batch mixer and fed as strips into the lab extruder. For the EPDM, the masterbath was used as a control. Table 1 shows the composition of example masterbatches.

Equipment used: An 11 mm and 2-lobe twin screw extruder (co-rotating) (ThermoFisher Scientific, Inc.) was utilized with the following extruder and process settings: 40 L/D (length/outside diameter); 7 barrel zones and die block (8-0); Clamshell barrel; 900 max rpm; 50˜1500 g/hr (for the rubbers tested); 90 bar max pressure; 1 solid feed & 1 liquid feed.

Mixture Preparation: All of the components shown in Table 1 were premixed in a 75 mL Brabender mixer.

In Table 1, ENB refers to ethylidene norbornene; N330 is a carbon black available from Continental Carbon Company of Houston, TX; Chimassorb® 2020 is a high-molecular-weight, hindered amine light stabilizer from BASF Corporation of Florham Park, NJ; Escorez® 5300 is a tackifier available from the ExxonMobil Chemical Company of Houston, TX; VM™ 3000 is a semi-amorphous polymer available from the ExxonMobil Chemical Company in Houston, TX; AkroZinc® Bar 85 is a dispersion of zinc oxide in naphthenic oil available from Akrochem Corporation of Akron, OH; stearic acid was purchased from ACROS Organics; and sulfur was obtained from Harwick Standard Distribution Corporation of Akron, OH.

TABLE 1
Composition of MBs (phr)

| | MB 1 | MB 2 | | |
|---|---|---|---|---|
| | EPDM | EPDM | MB 3 | MB 4 |
| MB Sample No. | (5 wt % C2, | (5 wt % C2, | Butyl | Butyl |
| Polymer | 2.5 wt % ENB) | 2.5 wt % ENB) | 065 | 268 |
| Amount of polymer | 100 | 100 | 100 | 100 |
| Sulfur | 2.5 | 2.5 | 2.5 | 2.5 |
| N330 | 0.2 | 0.2 | 0.2 | 0.2 |
| Chimassorb 2020 | 0.2 | 0.2 | 0.2 | 0.2 |
| Escorez 5300 | | 15 | | |
| VM 3000 | | 5 | | |
| AkroZinc ® | 1 | 1 | 1 | 1 |
| Bar 85 | | | | |
| Stearic acid | 1 | 1 | 1 | 1 |
| Total phr | 104.9 | 124.9 | 104.9 | 104.9 |

### Example Extrusion Process and Screw Designs

Four screw designs (screw design examples 1-4, below) were tested to assess, e.g., the overall mixing intensity and the distribution of mixing along the extruder of the sulfur functionalization.

Screw Design Example 1: This screw design includes three mixing zones. Each mixing zone includes both forward kneading elements and neutral kneading elements. The first kneading zone starts at 1.0 fold of the length of the longest kneading zone from the feed throat. The first kneading zone has a total length of 5 L/D and a ratio of 0.667 of the length of the forward kneading elements versus the length of the neutral kneading elements. The second kneading zone has a total length of 3 L/D and a ratio of 2 of the length of the forward kneading elements versus the length of the neutral kneading elements. The third kneading zone has a total length of 3.5 L/D and a ratio of 0.8 of the length of the forward kneading elements versus the length of the neutral kneading elements. The distance between the first and second kneading zones is 1.2 fold of the length of the longest kneading zone. The distance between the second and the third kneading zones is 0.9 fold of the length of the longest kneading zone.

Screw Design Example 2: This screw design includes four mixing zones. Each mixing zone includes both forward kneading elements and neutral kneading elements. The first kneading zone starts at 1.0 fold of the length of the longest kneading zone from the feed throat. The first kneading zone has a total length of 5 L/D and a ratio of 0.667 of the length of the forward kneading elements versus the length of the neutral kneading elements. The second kneading zone has a total length of 3 L/D and a ratio of 2 of the length of the forward kneading elements versus the length of the neutral kneading elements. The third kneading zone has a total length of 3 L/D and a ratio of 2 of the length of the forward kneading elements versus the length of the neutral kneading elements. The fourth kneading zone has a total length of 5 L/D and a ratio of 0.667 of the length of the forward kneading elements versus the length of the neutral kneading elements. The distance between the first and second kneading zones is 0.6 fold of the length of the longest kneading zone. The distance between the second and the third kneading zones is 0.6 fold of the length of the longest kneading zone. The distance between the third and the fourth kneading zones is 0.6 fold of the length of the longest kneading zone.

Screw Design Example 3: This screw design includes four mixing zones. Each mixing zone includes both forward kneading elements and neutral kneading elements. The first kneading zone starts at 1.0 fold of the length of the longest kneading zone from the feed throat. The first kneading zone has a total length of 5 L/D and a ratio of 0.667 of the length of the forward kneading elements versus the length of the neutral kneading elements. The second kneading zone has a total length of 3 L/D and a ratio of 2 of the length of the forward kneading elements versus the length of the neutral kneading elements. The third kneading zone has a total length of 3 L/D and a ratio of 2 of the length of the forward kneading elements versus the length of the neutral kneading elements. The fourth kneading zone has a total length of 5 L/D and a ratio of 0.667 of the length of the forward kneading elements versus the length of the neutral kneading elements. The distance between the first and second kneading zones is 0.4 fold of the length of the longest kneading zone. The distance between the second and the third kneading zones is 0.4 fold of the length of the longest kneading zone. The distance between the third and the fourth kneading zones is 1.1 fold of the length of the longest kneading zone.

Screw Design Example 4: This screw design includes four mixing zones. Each mixing zone includes both forward kneading elements and neutral kneading elements. The first kneading zone starts at 1.0 fold of the length of the longest kneading zone from the feed throat. The first kneading zone has a total length of 5 L/D and a ratio of 0.667 of the length of the forward kneading elements versus the length of the neutral kneading elements. The second kneading zone has a total length of 3 L/D and a ratio of 2 of the length of the forward kneading elements versus the length of the neutral kneading elements. The third kneading zone has a total length of 3 L/D and a ratio of 2 of the length of the forward kneading elements versus the length of the neutral kneading elements. The fourth kneading zone has a total length of 5 L/D and a ratio of 0.667 of the length of the forward kneading elements versus the length of the neutral kneading elements. The distance between the first and second kneading zones is 1.0 fold of the length of the longest kneading zone. The distance between the second and the third kneading zones is 0.4 fold of the length of the longest kneading zone. The distance between the third and the fourth kneading zones is 0.4 fold of the length of the longest kneading zone.

Screw Design Example 4-3: This screw design consists of four mixing zones. The each mixing zone consists of both the forward kneading elements and neutral kneading elements. The first kneading zone starts at 1.0 fold of the length of the longest kneading zone from the feed throat. The first kneading zone has a total length of 5 L/D and a ratio of 0.667 of the length of the forward kneading elements versus the length of the neutral kneading elements. The second kneading zone has a total length of 3 L/D and a ratio of 2 of the length of the forward kneading elements versus the length of the neutral kneading elements. The third kneading zone has a total length of 3 L/D and a ratio of 2 of the length of the forward kneading elements versus the length of the neutral kneading elements. The fourth kneading zone has a total length of 5 L/D and a ratio of 0.667 of the length of the forward kneading elements versus the length of the neutral kneading elements. The distance between the first and second kneading zones is 0.6 fold of the length of the longest kneading zone. The distance between the second and the third kneading zones is 0.5 fold of the length of the longest kneading zone. The distance between the third and the fourth kneading zones is 0.7 fold of the length of the longest kneading zone.

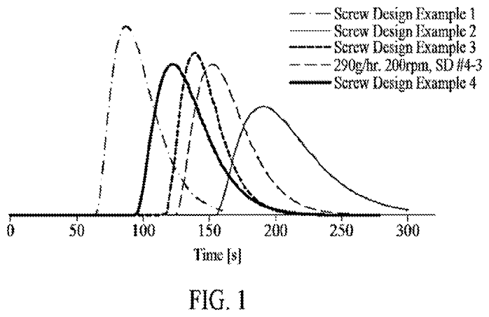

The premixed mixture of components (e.g., (1) EPDM or butyl and (2) other additives) was fed into the feed throat under a set of barrel temperature and extruder rpm for a given screw design. The process conditions as well as process responses for the inventive samples are listed in Table 2, and FIG. 1 is a graph illustrating the residence time distribution for the various example screw designs.

Table 2 shows process conditions and process responses for the examples. Table 2 also shows the degree of functionalization as determined by the ratio of the 1H-NMR integration values for the proton signal at ˜ 2.8-3.5 ppm (—CH₂—S—CH(CH₃)₂) to the vinylic proton signal at ˜ 4.8-5.5 ppm. The data in Table 2 indicate that the degree of functionalization can be controlled by process conditions of the present disclosure.

TABLE 2

| | Sample | | | | | | | |
|---|---|---|---|---|---|---|---|---|
| | Ex. 1 | Ex. 2 | Ex. 3 | Ex. 4 | Ex. 5 | Ex. 6 | Ex. 7 | Ex. 8 |
| Rubber | EPDM | EPDM | EPDM | EPDM | EPDM | Butyl | Butyl | EPDM |
| | | | | | | 065 | 268 | |
| Master Batch | MB 1 | MB 1 | MB 2 | MB 1 | MB1 | MB 3 | MB 4 | MB 1 |
| Screw Design | Ex. 1 | Ex. 2 | Ex. 2 | Ex. 3 | Ex. 4-3 | Ex. 4 | Ex. 4 | Ex. 1 |
| Set | 210 | 215 | 215 | 215 | 215 | 215 | 215 | 210 |
| temperature, ° C. | | | | | | | | |
| Rpm | 300 | 200 | 100 | 200 | 200 | 60 | 30 | 100 |
| Die pressure, psi | 31 | 28 | 19 | 45 | 34 | 44 | 51 | 22 |
| Die | 202 | 206 | 204 | 206 | 207 | 204 | 203 | 199 |
| temperature, ° C. | | | | | | | | |
| Torque, % | 91 | 93 | 81.9 | 91 | 81.4 | 80 | 98.4 | 68.5 |
| Power, kW | 0.34 | 0.23 | 0.1 | 0.22 | 0.20 | 0.06 | 0.03 | 0.08 |
| Rate, g/h | 1,515 | 945 | 1,013 | 1,223 | 1,108 | 540 | 255 | 587 |
| S.E., kW/kg | 0.224 | 0.243 | 0.099 | 0.182 | 0.181 | 0.111 | 0.118 | 0.136 |
| Ratio of S—CHₓ | 0.37 | 0.47 | 0.26 | 1.42 | 1.09 | 1.05 | 0.73 | |
| to vinylic H | | | | | | | | |

### Characterization

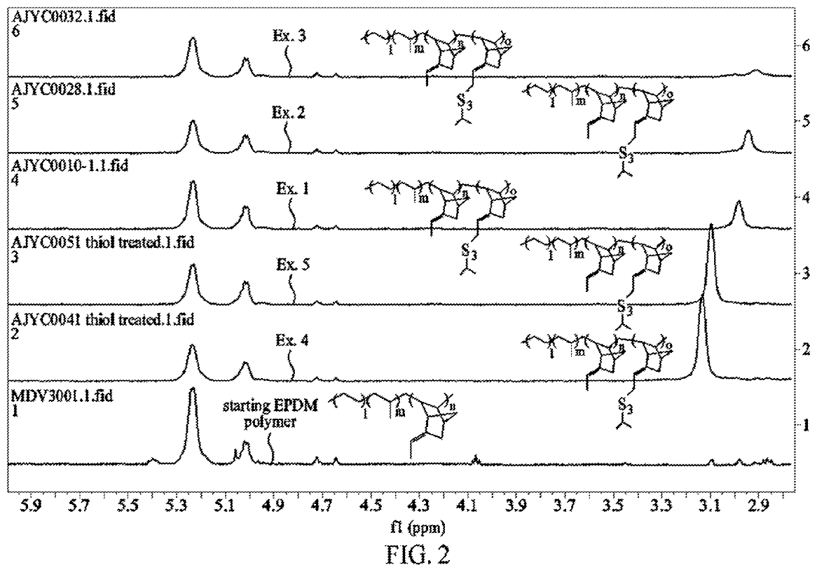

The functionalized polymers shown in Table 3 were subjected to a thiol-amine chemical probe treatment using a similar method reported in the literature (Sombatsompop, N., (1998), Analysis of cure characteristics on cross-link density and type, and viscoelasitc properties of natural rubber, Polym.-Plast. Technol. Eng., 37 (3), 333-349). The thiol solution includes 0.4 M of 2-propanethiol and 0.5 M of piperidine in heptane. The sulfur functionalized polymers were immersed in the thiol solution for at least 24 h at 25° C. until completely dissolved. The purpose of the thiol treatment is to cleave the polysulfidic bonds and cap it with the 2-propanethiol group. The end capping sulfur functionalized polymer samples were then coagulated twice with acetone to remove all unbound sulfur and dried in a vacuum oven for at least 24 h. 1H-NMR was used to analyze the thiol treated samples to show sulfur incorporation as illustrated in FIG. 2. The proton signal ˜3 ppm signifies the presence of bound sulfur on the functionalized polymer backbone where the bound polysulfidic bonds were cleaved and capped with the propane thiol reagent.

FIG. 2 illustrates 1H-NMR spectra of example thiol-treated, sulfur functionalized EPDM examples (Ex. 3, Ex. 2, Ex. 1, Ex. 5, and Ex. 4) and the untreated EPDM.

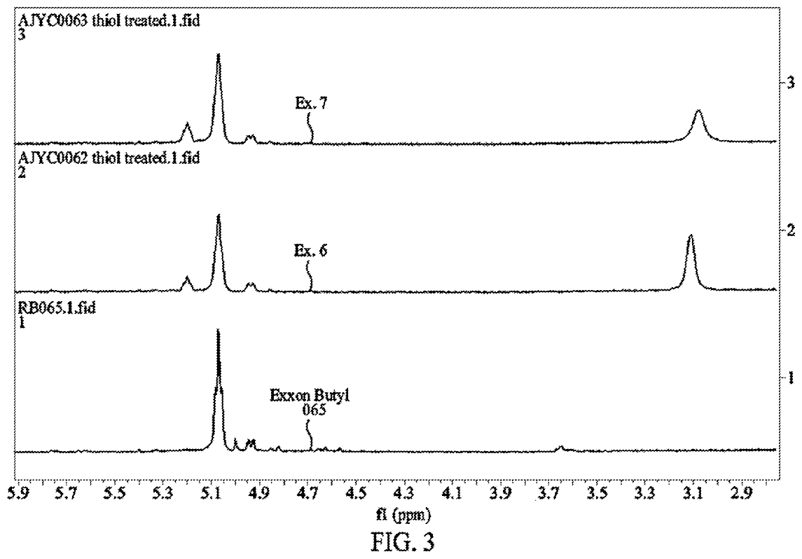

FIG. 3 illustrates 1H-NMR spectra of example thiol-treated, sulfur functionalized butyl rubber examples (Ex. 7 and Ex. 6) and the untreated butyl rubber (Exxon Butyl 065).

Table 3 shows the degree of functionalization as determined by the ratio of the ¹H-NMR integration values for the proton signal at ˜ 2.8-3.5 ppm (—CH₂—S—CH(CH₃)₂) to the vinylic proton signal at ca. 4.8-5.5 ppm. The relative degree of functionalization is varied and is dependent on the process conditions discussed earlier.

TABLE 3
¹H NMR Integration Data

| Sample | Polymer base | Ratio of S—CHₓ to vinylic H |
|---|---|---|
| Ex. 1 | EPDM | 0.37 |
| Ex. 2 | EPDM | 0.47 |
| Ex. 3 | EPDM | 0.26 |
| Ex. 4 | EPDM | 1.42 |
| Ex. 5 | EPDM | 1.09 |
| Ex. 6 | Butyl | 1.05 |
| Ex. 7 | Butyl | 0.73 |

The results in Table 3 indicate that degree of functionalization can be controlled by process conditions of the present disclosure and applied in general to unsaturated polymers such as EPDM and butyl rubber.

### Tread Compound and Mixing

Table 4 shows the composition of an example tread compound. In Table 4, NIPOL® NS 116R is a styrene butadiene rubber with 21% bound styrene, available from Zeon Corporation; amorphous silica known as ZEOSIL® 1165MP is from Rhodia; high-cis butyl rubber known as BUNA® CB24 is from Arlanxeo; silane coupling agent TESPT known as Si69® is from Evonik Industries; high viscosity naphthenic black oil known as NYTEX® 4700 is from Nynas AB; N-(1,3-Dimethylbutyl)-N′-phenyl-p-phenylenediamine known as Santoflex® 6-PPD is from Flexsys; carbon black known as Vulcan®3 N330 is from Cabot Corp.; zinc oxide in naphthenic oil known as AKRO-ZINC® BAR 85 is from Akrochem Corp.; N-cyclohexyl-2-benzothiazylsulfenamide known as CBS is from Kemai Chemical Co.; and diphenyl guanidine known as Ekaland DPG is from MLPC International (Arkema).

TABLE 4
Composition of an Example Tread Compound

| | Amount (phr) |
|---|---|
| NS 116R | 67 |
| CB 24 | 33 |
| Silica Z 1165 | 75 |
| Si 69 | 6.4 |
| Nytex 4700 | 15 |
| 6PPD | 3 |
| N330 | 5 |
| Stearic acid | 2.5 |
| Functionalized polymer | 20 |
| (of Ex. 1, 2, 3, or 8) | |
| AkroZinc ® Bar 85 | 2 |
| CBS | 1.5 |
| Sulfur | 1.4 |
| DPG | 1.8 |

Table 4 an example tire tread composition.

### Results for Functionalized Polymers Compounded for Use in Tire Treads:

Tensile modulus at 300% elongation (300% modulus), tensile strength, and elongation at break were determined.

### Stress/Strain Measurements

Five test specimens were dies out with ASTM D4482 die and conditioned in the lab for 16 hours before testing. Specimens were tested on an Instron 5565 with a long travel mechanical extensometer. The load cell and extensometer were calibrated before each day of testing. Extensometer was calibrated @20 mm as gauge length. Sample information, operator name, date, lab temperature, and humidity were all recorded. Specimen thickness was measured at three places in the test area. The average value was entered when prompted. The lab temperature and humidity were measured. Specimens were carefully loaded in the grips to ensure grips clamp on each specimen symmetrically. The extensometer grips were then attached to the sample in the test area. The test was prompted to start. A pre-load of 0.1N was applied. Testing began with the crosshead moving at 20 inches/minute until a break was detected. Five specimens from each sample were tested and the median values were used for reporting.

### Dynamic Mechanical Thermal Analysis

All tread formulations were compression molded and cured into pads. Afterward, a rectangular test specimen (12 mm wide & 30 mm long) was died out of the cured pads and mounted in an ARES G2 (Advanced Rheometric Expansion System, TA instruments) for dynamic mechanical testing in torsion rectangular geometry. Though the thickness of the test specimen was around 1.8 mm, the thickness of the specimens varied and was measured manually for each test. A strain sweep at room temperature up to 5.5% strains and at 10 Hz was conducted first followed by a temperature sweep at 4% strain and 10 Hz from −26° C. to 100° C. at 2° C./min ramp rates. Storage and loss moduli were measured along with the loss tangent values. For better wet traction, it is preferred to have higher loss tangent values at a temperatures of 0° C. For better rolling resistance, the loss tangent is preferred to be lower at a temperature of 60° C.

Area under the curve is a measure of energy (Joules) to break and tensile properties. Typically, the higher the number, the more robust the composition is and the higher energy fracture is.

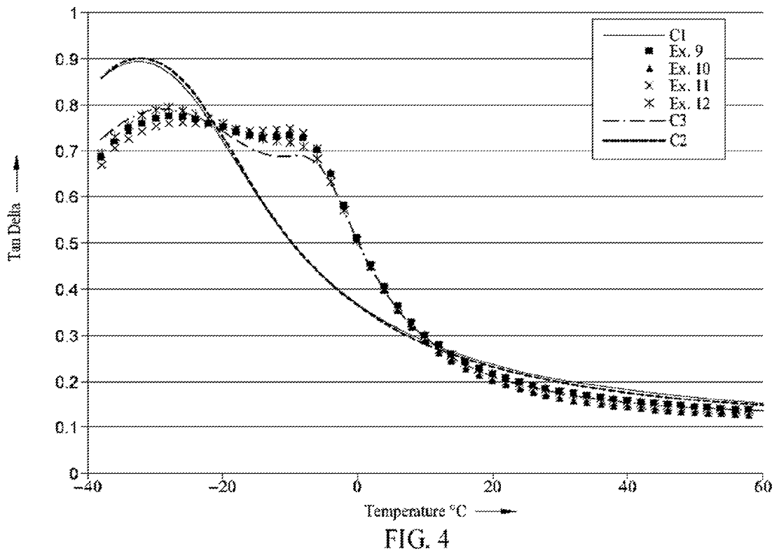

FIG. 4 is a graph illustrating the results from dynamic mechanical thermal analysis (DMTA) measurements at 4% strain and 10 Hz of compositions.

Table 5 shows various example tire tread compositions and physical properties thereof. For the comparative example, compounded EPDM MB (which has shown improved performance in various applications) shows poor physical properties when incorporated into a tire treads. The poor physical properties suggests that the wear performance of this tire tread compound is reduced. Table 5 illustrates two sets of numbers for each of the physical properties—the first set of data are the actual absolute test results, and the second set of data is the normalized results for relative comparison where sample 21-77 (Ex. 3) is used as a control.

The physical properties of the example tire tread compositions having functionalized polymers—Example Nos. 4-7—is much better than the non-functionalized polymer Example 3 with the rupture energy getting close to the control treads which have no additive. The results also indicate that use of the functionalized polymer improves various performance properties, e.g., wet braking (tan δ at 0° C.), rolling resistance (tan δ at 60° C.), and wear performance. An indirect measure of the interface between the EPDM polymer and the tread matrix (tan δ at −12° C.) suggests the highly functionalized polymer provides improved polarity match between the functionalized polymer and the tread matrix.

TABLE 5

| | Composition No. | | | | | | | | | | |
|---|---|---|---|---|---|---|---|---|---|---|---|
| | | | | Ex. 9 | Ex. 10 | Ex. 11 | Ex. 12 | | | | |
| | | | | Sample | | | | | | | |
| | C1 | C2 | C3 | Ex. 8 | Ex. 1 | Ex. 2 | Ex. 3 | Ex. 4 | Ex. 5 | Ex. 6 | Ex. 7 |
| MasterBatch formulation | | | MB 1 | MB 1 | MB 1 | MB 1 | MB 2 | MB 1 | MB 1 | MB 3 | MB 4 |
| rpm | — | — | — | 100 | 300 | 200 | 100 | 200 | 200 | 60 | 30 |
| Screw Design Example | — | — | — | 1 | 1 | 2 | 2 | 3 | 4-3 | 4 | 4 |
| No. | | | | | | | | | | | |
| Temperature, ° C. | — | — | — | 210 | 210 | 215 | 215 | 215 | 215 | 215 | 215 |
| EPDM | — | — | 100 | 100 | 100 | 100 | 100 | 100 | 100 | — | — |
| Butyl rubber 065 | — | — | — | — | — | — | — | — | — | 100 | — |
| Butyl Rubber 268 | — | — | — | — | — | — | — | — | — | — | 100 |
| Escorez ™ 5300 | — | — | — | — | — | — | 15 | — | — | — | — |
| VM ™ 3000 | — | — | — | — | — | — | 5 | — | — | — | — |
| Physical Properties | | | | | | | | | | | |
| 300% Modulus, MPa | 12.8 | 13.3 | 13 | 11.8 | 12.1 | 12.4 | 11.9 | — | — | — | — |
| Tensile strength, MPa | 18.3 | 17.2 | 14.4 | 15.5 | 16.5 | 16.7 | 16.5 | — | — | — | — |
| Elongation @ break, % | 386 | 362 | 339 | 369 | 384 | 377 | 403 | — | — | — | — |
| Rupture energy (area | 0.596 | 0.531 | 0.441 | 0.49 | 0.551 | 0.545 | 0.592 | — | — | — | — |
| under the curve), J | | | | | | | | | | | |
| Physical Properties | | | | | | | | | | | |
| (normalized to control | | | | | | | | | | | |
| sample) | | | | | | | | | | | |
| 300% Modulus, MPa | 99 | 102 | 100 | 91 | 93 | 95 | 91 | — | — | — | — |
| Tensile strength, MPa | 127 | 119 | 100 | 108 | 115 | 116 | 115 | — | — | — | — |
| Elongation @ break, % | 114 | 107 | 100 | 109 | 113 | 111 | 119 | — | — | — | — |
| Rupture energy (area | 135 | 120 | 100 | 111 | 125 | 124 | 134 | — | — | — | — |
| under the curve), J | | | | | | | | | | | |
| DMTA | | | | | | | | | | | |
| Tan delta (−12° C.) | 0.542 | 0.545 | 0.688 | 0.730 | 0.741 | 0.748 | 0.721 | — | — | — | — |
| Tan delta (0° C.) | 0.366 | 0.363 | 0.503 | 0.512 | 0.511 | 0.507 | 0.507 | — | — | — | — |
| Tan delta (60° C.) | 0.151 | 0.147 | 0.136 | 0.135 | 0.125 | 0.13 | 0.139 | — | — | — | — |
| DMTA (normalized to | | | | | | | | | | | |
| control sample) | | | | | | | | | | | |
| Tan delta (−12° C.) | 79 | 79 | 100 | 106 | 108 | 109 | 105 | — | — | — | — |
| Tan delta (0° C.) | 73 | 72 | 100 | 102 | 102 | 101 | 101 | — | — | — | — |
| Tan delta (60° C.) | 111 | 108 | 100 | 100 | 93 | 96 | 102 | — | — | — | — |
| ¹H NMR | | | | | | | | | | | |
| vinylic proton (1 H), | — | — | — | — | 4.9-5.4 | 4.8-5.5 | 4.9-5.5 | 4.8-5.7 | 4.9-5.4 | 4.8-5.3 | 4.9-5.3 |
| ppm | | | | | | | | | | | |
| Integration result of | — | — | — | — | 8939 | 4077 | 4978 | 5083 | 5382 | 5128 | 6530 |
| vinylic proton | | | | | | | | | | | |
| Protons (3 H's) adjacent | — | — | — | — | 2.8-3.2 | 2.8-3.2 | 2.8-3.2 | 2.9-3.5 | 2.9-3.3 | 2.8-3.6 | 2.8-3.3 |
| to sulfur, ppm | | | | | | | | | | | |
| Integration result of | — | — | — | — | 2226 | 1913 | 1290 | 7217 | 5840 | 5372 | 4783 |
| protons adjacent to sulfur | | | | | | | | | | | |
| Ratio ofprotons adjacent | — | — | — | — | 0.375 | 0.469 | 0.259 | 1.42 | 1.085 | 1.048 | 0.732 |
| to sulfur to vinylic proton | | | | | | | | | | | |

Overall, the present disclosure provides extrusion methods capable of providing functionalized polymers having a high degree of functionalization. The functionalized polymers can be used in compositions, e.g., tire tread compositions that provide improved wet traction and rolling resistance while maintaining wear resistance performance.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the present disclosure, additionally, they do not exclude impurities and variances normally associated with the elements and materials used.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All numerical values within the detailed description herein are modified by “about” the indicated value, and take into account experimental error and variations that would be expected by a person having ordinary skill in the art.

All documents described herein are incorporated by reference herein, including any priority documents and or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including” for purposes of United States law. Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

While the present disclosure has been described with respect to a number of embodiments and examples, those skilled in the art, having benefit of this disclosure, will appreciate that other embodiments can be devised which do not depart from the scope and spirit of the present disclosure.

We claim:

1. A method of forming a functionalized polymer, the method comprising:
introducing a polymer and a coupling agent to an extruder at a feed throat of the extruder; and
extruding the polymer and the coupling agent through at least a portion of the extruder via a plurality of intermeshing screws disposed within the extruder to form the functionalized polymer,
wherein at least one screw of the plurality of intermeshing screws has a first mixing zone having a total length of about 4 L/D to about 6 L/D, a second mixing zone having a total length of 2.5 L/D to 3.5 L/D, and a third mixing zone having a total length of about 2.5 L/D to about 4.5 L/D,
wherein the first mixing zone is a mixing zone closest to the feed throat of the extruder, the second mixing zone is disposed downstream of the first mixing zone relative to the feed throat, and the third mixing zone is disposed downstream of the second mixing zone relative to the feed throat.

2. The method of claim 1, wherein the at least one screw has:
a fourth flow zone having one or more conveying elements and is disposed between the first mixing zone and the second mixing zone, and
a fifth flow zone having one or more conveying elements and is disposed between the second mixing zone and the third mixing zone.

3. The method of claim 1, wherein each of the first mixing zone, the second mixing zone, and the third mixing zone have one or more left handed (forward) kneading blocks and one or more neutral convey kneading blocks.

4. The method of claim 1, wherein the first mixing zone has a total length of about 5 L/D.

5. The method of claim 3, wherein the first mixing zone has a ratio of total length of the one or more left handed (forward) kneading blocks of the first mixing zone to total length of the one or more neutral convey kneading blocks of the first mixing zone of about 0.5 to about 0.75.

6. The method of claim 5, wherein the ratio of the first mixing zone is about 0.67.

7. The method of claim 1, wherein the second mixing zone has a total length of about 3 L/D.

8. The method of claim 3, wherein the second mixing zone has a ratio of total length of the one or more left handed (forward) kneading blocks of the second mixing zone to total length of the one or more neutral convey kneading blocks of the second mixing zone of about 0.8 to about 2.

9. The method of claim 8, wherein the ratio is about 1 to about 1.3.

10. The method of claim 3, wherein the third mixing zone has a ratio of total length of the one or more left handed (forward) kneading blocks of the third mixing zone to total length of the one or more neutral convey kneading blocks of the third mixing zone of about 0.5 to about 2.5.

11. The method of claim 1, wherein introducing the polymer and the coupling agent to the feed throat comprises introducing the polymer and the coupling agent to an initial flow zone of the at least one screw upstream of the first mixing zone, the initial flow zone having one or more conveying elements.

12. The method of claim 11, wherein extruding the polymer and the coupling agent through the at least a portion of the extruder comprises extruding the polymer and the coupling agent from the initial flow zone to the first mixing zone, and the first mixing zone begins at about 0.8× to about 1.2× length of a longest mixing zone of the at least one screw.

13. The method of claim 1, wherein the at least one screw has a distance between the first mixing zone and the second mixing zone of about 0.3× to 2× length of a longest mixing zone of the screw.

14. The method of claim 13, wherein the distance between the first mixing zone and the second mixing zone is about 0.6× to about 1×.

15. The method of claim 13, wherein the at least one screw has a distance between the second mixing zone and the third mixing zone of about 0.0.15× to about 1.5× length of the longest mixing zone of the screw.

16. The method of claim 3, wherein the at least one screw further comprises a fourth mixing zone comprising one or more forward (left handed) kneading blocks and one or more neutral convey kneading blocks, the fourth mixing zone disposed downstream of the third mixing zone relative to the feed throat of the extruder.

17. The method of claim 16, wherein the fourth mixing zone has a total length of about 4 L/D to about 6 L/D.

18. The method of claim 17, wherein the fourth mixing zone has a ratio of total length of the one or more left handed (forward) kneading blocks of the fourth mixing zone to total length of the one or more neutral convey kneading blocks of the fourth mixing zone of about 0.5 to about 1.

19. The method of claim 18, wherein the ratio is about 0.67.

20. The method of claim 18, wherein the at least one screw has a distance between the third mixing zone and the fourth mixing zone of about 0.2× to about 1.7× length of a longest mixing zone of the screw.

21. The method of claim 1, further comprising introducing additives to the extruder to form a composition comprising the additives and the functionalized polymer.

22. The method of claim 1, wherein extruding the polymer and the coupling agent through the at least a portion of the extruder is performed at an average extruder temperature of about 200° F. to about 300° F.

23. The method of claim 22, wherein extruding the polymer and the coupling agent through the at least a portion of the extruder is performed by rotating the at least one screw of the plurality of screws at a rate of about 0 rpm to about 375 rpm.

24. The method of claim 1, wherein the polymer is selected from the group consisting of a butyl rubber, an ethylene-propylene-diene terpolymer, a poly(isobutylene-co-para-methylstyrene-co-isoprene) terpolymer, and combination(s) thereof.

25. The method of claim 24, wherein the functionalized polymer is selected from the group consisting of a functionalized butyl rubber, a functionalized ethylene-propylene-diene terpolymer, a functionalized poly(isobutylene-co-para-methylstyrene-co-isoprene) terpolymer, and combination(s) thereof.

26. The method of claim 1, wherein the coupling agent is selected from the group consisting of:
bis[3-(triethoxysilyl)propyl]polysulfide,
bis[3-(methyl diethoxysilyl)propyl]polysulfide,
bis[3-(octyl diethoxysilyl)propyl]polysulfide,
bis[3-(diethoxy octyloxysilyl)propyl]polysulfide,
bis[3-(ethoxy dioctyloxysilyl)propyl]polysulfide,
bis[8-(triethoxysilyl)octyl]polysulfide,
bis[8-(methyl diethoxysilyl)octylpolysulfide, and
combination(s) thereof.

27. The method of claim 1, wherein the coupling agent is elemental sulfur.
